(19) United States
(12) Patent Application Publication
(10) Pub. No.: US 2003/0210874 A1
(43) Pub. Date: Nov. 13, 2003

(54) Optical composite module, optical wavelength multiplexer, optical wavelength demultiplexer, and optical composite module manufacturing method

(76) Inventors: Hironori Souda, Hirakata (JP); Tomoaki Ohira, Moriguchi (JP)

Correspondence Address: WENDEROTH, LIND & PONACK, L.L.P., 2033 K STREET N. W., SUITE 800, WASHINGTON, DC, 20006-1021, US

(21) Appl. No.: 10/396,356

(22) Filed: Mar. 26, 2003

(30) Foreign Application Priority Data
Mar. 27, 2002 (JP) 2002-89058

(51) Int. Cl. G02B 6/42

(52) U.S. Cl. 385/89; 385/93

(57) ABSTRACT

An optical composite module whose optical axis can be easily adjusted, which is small-sized and has an advantage in ease of mountability. A convergent rod lens 2 with a band-pass optical filter 5 (BPF) bonded to an end thereof, and a double-core glass tube 3 housing an input optical fiber 1a and an output optical fiber 1b are secured. The double-core glass tube 3 has an outer diameter coinciding with that of the convergent rod lens 2. The center line between the input optical fiber 1a and the output optical fiber 1b coincides with an optical axis of the convergent rod lens Light with wavelength λ4 output from the input optical fiber 1a passes through the BPF 5, and is received by a light-receiving element 7 and converted into an electric signal. Light with other wavelengths output from the input optical fiber 1a is reflected by the BPF 5, and coupled into the output optical fiber 1b.

### BACKGROUND OF THE INVENTION

1. Field of the Invention

The present invention relates to optical composite modules in use for optical fiber communications, which have either an optical multiplex or optical demultiplex function, and optical wavelength multiplexers and optical wavelength demultiplexer using the optical composite modules. More particularly, the present invention relates to an optical composite module including either a light-emitting element or a light-receiving element, and an optical wavelength multiplexer and an optical wavelength demultiplexer using the optical composite module.

2. Description of the Background Art

In dense wavelength-division multiplexing, wavelengths have to be separated accurately due to an arrow wavelength interval. Thus, it is necessary to use an optical filter having steep wavelength characteristics. However, the steep wavelength characteristics require a coating of multiple layers no less than 100, and an incident angle with the normal to the surface of the filter cannot be increased, which results in more constraints on the structure of an optical coupled system.

Under the above-described conditions, an interference filter-based optical demultiplexer was proposed circa 1978 in order to effectively multiplex/demultiplex optical signals closely spaced at dense wavelength intervals. The interference filter-based optical demultiplexer uses an optical filter inserted between two convergent rod lenses.

FIG. 21 is an illustration showing the structure of a conventional interference filter-based optical multiplexer. In FIG. 21, an optical multiplexer/demultiplexer 1100 multiplexes/demultiplexes light with wavelengths λ1 and λ2, and includes a first convergent rod lens 1000, a second convergent rod lens 1001, and a band-pass optical filter (hereinafter referred to as “BPF”) 1002 that passes light with wavelength λ1 but reflects light with wavelength λ2. Optical fibers 1003 and 1004 are connected to one end of the first convergent rod lens 1000, and an optical fiber 1005 is connected to one end of the second convergent rod lens 1001.

Light with wavelength λ2 output from the optical fiber 1004 is converted into collimated light by the first convergent rod lens 1000. The converted light then travels toward the BPF 1002, and is reflected by the BPF 1002. The light with wavelength λ2 reflected by the BPF 1002 passes through the first convergent rod lens 1000 again, and is coupled into the optical fiber 1003. On the other hand, light with wavelength λ1 output from the optical fiber 1005 is converted into collimated light by the second convergent rod lens 1001. The converted light is then focused by the first convergent rod lens 1000 after passing through the BPF 1002, and also coupled into the optical fiber 1003. As such, the light with wavelength λ1 and the light with wavelength λ2 are multiplexed by being allowed to pass through the BPF 1002 or reflected thereby.

In order to demultiplex the light with wavelengths λ1 and λ2, the above-described process is carried out in reverse. That is, the light with wavelengths λ1 and λ2 is inputted from the optical fiber 1003 for extracting the light with wavelength λ2 from the optical fiber 1004 and extracting the light with wavelength λ1 from the optical fiber 1005.

However, the above-described conventional interference filter-based optical demultiplexer requires an additional light-emitting module for light transmission or an additional light-receiving element module for light reception to be connected to each end of the optical fibers 1003 to 1005, which results in an increased size of the device. Furthermore, other problems such as increased insertion loss due to the need of handling fusion splicing, etc, will also arise.

Therefore, an optical module including either a light-emitting element module or a light-receiving element module has been proposed. For example, Japanese Patent Laid-Open Publication No. H11-242130 discloses an optical module of such type. FIG. 22 is an illustration showing the structure of the optical module disclosed in Japanese Patent Laid-Open Publication No. H11-242130.

In FIG. 22, an optical module 2100 includes a light source 2000 emitting light with wavelength λ1, a lens 2001, a BPF 2002 that passes light with wavelength λ1 but reflects light with wavelength λ2, and a convergent rod lens 2003. The light with wavelength λ2 output from an optical fiber 2005 is converted into collimated light by the convergent rod lens 2003. The converted light then travels toward the BPF 2002, and is reflected by the BPF 2002. The light with wavelength λ2 reflected by the BPF 2002 passes through the convergent rod lens 2003 again, and is coupled into the optical fiber 2004. On the other hand, light with wavelength λ1 emitted from the light source 2000 is converted into collimated light by the lens 2001. The converted light is then focused by the convergent rod lens 2003 after passing through the BPF 2002, and also coupled into the optical fiber 2004. As such, the light with wavelength λ1 and the light with wavelength λ2 are multiplexed. The optical module 2100 includes the light source 2000 that is a light-emitting element emitting light with wavelength λ1, thereby realizing reduction of size and insertion loss.

As aforementioned, the conventional interference filter-based optical multiplexer/demultiplexer 1100 has the problems of such as the increased size of the device and the increase of insertion loss. In addition to those problems, the conventional interference filter-based optical demultiplexer makes it difficult to adjust a coupling between the optical fiber and the convergent rod lens. Specifically, in order to couple the light reflected by the BPF 1002 into the optical fiber 1003, it is necessary to coincide a center line between the optical fibers 1003 and 1004 with an optical axis of the first convergent rod lens 1000. Then, the optical axis has to be adjusted with a precision of less than 10 μm for determining whether the light is output from the optical fiber. Also, in order to couple light output from the optical fiber 1005 into the optical fiber 1003, it is necessary to perform positioning of the optical fiber 1005 at the end of the second convergent rod lens 1001 with a precision of less than 10 μm for determining whether the light is output from the optical fiber or not.

Furthermore, the use of the conventional interference filter-based optical multiplexer/demultiplexer 1100 in an optical wavelength multiplexer or an optical wavelength demultiplexer results in an increased size of the device and the increase of light loss, which is also a problem.

On the other hand, the optical module 2100 disclosed in Japanese Patent Laid-Open Publication No H11-242130 is smaller in size compared to an optical transmitting device using the multiplexer/demultiplexer 1100 of FIG. 21. The optical module 2100, however, requires a complicated manufacturing process. Specifically, in order to cause light output from the optical fiber 2005 to be reflected by the BPF 2002 and couple the reflected light into the optical fiber 2004, the optical axis of the convergent rod lens 2003 has to be coincided with a center line between the optical fibers 2004 and 2005. Thus, it is necessary to adjust the optical axis with a precision of less than 10 μm for determining whether the light is output from the optical fiber or not. Also, in order to input light with wavelength λ1 emitted from the light source 2000 into the convergent rod lens 2003 and couple the inputted light into the optical fiber 2004, the angles of the lens 2001 and the convergent rod lens 2003 have to be adjusted with a precision of less than an angle of 0.1 degrees.

### SUMMARY OF THE INVENTION

Therefore, an object of the present invention is to provide a small-sized, easily manufacturable, and low-loss optical composite module including either a light-emitting element or a light-receiving element, the optical composite module allowing easy adjustment of a position or an angle of a reflection coupled system.

Another object of the present invention is to provide an optical wavelength multiplexer and an optical wavelength demultiplexer that are small-sized and low-loss.

Furthermore, another object of the present invention is to provide an optical wavelength multiplexer and an optical wavelength demultiplexer using the above-described optical composite module.

The present invention has the following features to attain the object mentioned above.

A first aspect of the present invention is directed to an optical composite module that demultiplexes light having a plurality of wavelengths output from an input optical fiber for converting light of a predetermined range of wavelengths into an electric signal and outputting light outside of the predetermined wavelengths to an output optical fiber, comprising:

an optical filter that passes the light falling within a predetermined range of wavelengths to be converted into the electric signal, and reflects the light outside of the predetermined wavelengths;

a first convergent rod lens for converting the light output from the input optical fiber into collimated light for inputting into the optical filter, and focusing the collimated light reflected by the optical filter on an end of the output optical fiber, which is placed between the input and output optical fibers and the optical filter;

a light-converging section for focusing the collimated light passing through the optical filter on a single point;

a light-receiving element for receiving the light focused by the light-converging section and converting the received light into the electric signal; and

a positioning component for coinciding an optical axis of the first convergent rod lens with a center line between the input optical fiber and the output optical fiber.

According to the first aspect, the size of the optical module and insertion loss can be reduced. Furthermore, the optical axis of the first convergent rod lens coincides with the center line between the input optical fiber and the output optical fiber, whereby a coupling position can be adjusted easily.

Preferably, the positioning component may include:

a cylindrical lens holder for holding the first convergent rod lens, an axis of the lens holder coinciding with the axis of the first convergent rod lens; and

an optical fiber holder whose outer diameter is equal to that of the lens holder, the optical fiber holder having two guide holes for holding the input optical fiber and output optical fiber such that the two optical fibers are placed equidistant from an axis thereof.

As described above, the lens holder and the optical fiber holder are equal in outer diameter, thereby allowing the optical axis and the center line between the input optical fiber and the output optical fiber to be coincided with each other by only bringing an end of the lens holder into contact with that of the optical fiber holder.

Also preferably, the positioning component may be a package having two guide holes therein for holding the input optical fiber and the output optical fiber such that the two optical fibers are placed equidistant from the optical axis of the first convergent rod lens.

As described above, the first convergent rod lens and the optical fiber holder are equal in outer diameter, thereby allowing the optical axis and the center line between the optical fibers to be coincided with each other by only bringing an end of the first convergent rod lens into contact with that of the optical fiber holder.

For example, the light-converging section placed between the optical filter and the light-receiving element is a ball lens for focusing the collimated light output from the optical filter on the light-receiving element.

In this case, the use of the ball lens focusing the collimated light on the light-receiving element eliminates the need for a fine adjustment of an angle of the light-receiving element.

Furthermore, for example, the light-converging section includes:

a second convergent rod lens placed between the optical filter and the light-receiving element for focusing the collimated light passing through the optical filter; and

a ball lens placed between the second convergent rod lens and the light-receiving element for refocusing the light having been diverged after being focused by the second convergent rod lens on the light-receiving element.

In this case, it is only necessary to bring each end surface of the optical filter into contact with an end surface of the first convergent rod lens and that of the second convergent rod lens. Thus, a fine adjustment of angles of the optical filter and the lenses described above does not have to be performed, and a lens-equipped light-receiving element for general purpose use can be used.

Still further, the light-converging section placed between the optical filter and the light-receiving element is a second convergent rod lens for focusing the collimated light passing through the optical filter on the light-receiving element.

In this case, it is only necessary to bring each end surface of the optical filter into contact with an end surface of the first convergent rod lens and that of the second convergent rod lens. Thus, a fine adjustment of angles of the optical filter and the lenses described above does not have to be performed. Furthermore, even low-intensity light focused by the second convergent lens can be directly received. Thus, it is possible to place the light-receiving element at the optimum position with ease.

The optical composite module may further include a light-receiving element positioning component for placing the light-receiving element at a focal point determined by an action of the light-converging section.

Thus, the light-receiving element is placed at an appropriate position by only performing a one-dimensional angle adjustment.

More preferably, the light-receiving element positioning component may include:

a cylindrical holder whose axis coincides with the optical axis of the first convergent rod lens for holding the first convergent rod lens; and

a light-receiving element holder for holding the light-receiving element, whose outer diameter is equal to that of the cylindrical holder, wherein

the light-receiving element holder may lock the light-receiving element in a position corresponding to the focal point when being rotated so that a relative angle formed with the cylindrical holder is adjusted to the predetermined angle.

Thus, the light-receiving element is placed at an appropriate position by only rotating the light-receiving element holder about the optical axis for adjusting a relative angle that the light-receiving element holder forms with the cylindrical holder.

A second aspect of the present invention is directed to an optical composite module that outputs light modulated by an inputted electric signal and multiplexes the modulated light and light having a plurality of wavelengths output from an input optical fiber for output to an output optical fiber, comprising:

a light-emitting element for emitting the light modulated by the inputted electric signal;

a collimator for converting the light emitted from the light-emitting element into collimated light;

an optical filter that passes light of a predetermined range of wavelengths inputted from the collimator and reflects light outside of the predetermined wavelengths among light inputted thereinto, which is placed between the collimator and the input and output optical fibers;

a first convergent rod lens placed between the optical filter and the input and output optical fibers for converting the light output from the input optical fiber into collimated light, inputting the converted light into the optical fiber, and focusing the collimated light reflected by the optical filter and the collimated light passing through the optical filter on an end of the output optical fiber; and

a positioning component for coinciding an optical axis of the first convergent rod lens with a center line between the input optical fiber and the output optical fiber.

According to the second aspect, the size of the optical module and insertion loss can be reduced. Also, the positioning component ensures coincidence between the optical axis of the first convergent rod lens and the center line between the input optical fiber and the output optical fiber, whereby a coupling position can be adjusted easily.

Preferably, the collimator may include:

a converging lens for focusing divergent light emitted from the light-emitting element on a single point; and

a second convergent rod lens placed between the optical filter and the converging lens for converting the light focused by the converging lens into collimated light and inputting the converted light into the optical filter.

Thus, the light emitted from the light-emitting element is converted into collimated light, and enters the optical filter.

More preferably, the optical composite module may further include a back reflection preventing section placed between the converging lens and the second convergent rod lens for preventing the light, which is output from the converging lens and reflected by an end of the second convergent rod lens, from returning to the light-emitting element.

Thus, the light reflected by the end of the second convergent lens is prevented from returning to the light-emitting element.

For example, the back reflection preventing section is an optical isolator.

Thus, the use of the optical isolator ensures that light is prevented from returning to the light-emitting element.

Furthermore, for example, the back reflection preventing section may prevent back reflection by angling an end of the second convergent rod lens.

Thus, the angle of the end of the second convergent rod lens changes the traveling direction of the light reflected at the end of the second convergent rod lens so as not to hit the light-emitting element, thereby preventing the reflected light from entering the light-emitting element.

Still further, for example, the back reflection preventing section is an antireflective coating provided to an end of the second convergent rod lens.

Thus, the antireflective coating can minimize the reflection at the end of the second convergent rod lens.

For example, the converging lens is a ball lens.

Thus, it is possible to use a light-emitting element for general purpose use, and also possible to increase an amount of light to be received.

Furthermore, for example, the converging lens is a rounded-end convergent rod lens whose lens end facing the light-emitting element is rounded.

Thus, the rounded-end of the lens can increase an amount of light to be received.

Preferably, the positioning component includes:

a cylindrical lens holder for holding the first convergent rod lens, an axis of the lens holder coinciding with the axis of the first convergent rod lens; and

an optical fiber holder whose outer diameter is equal to that of the lens holder, the optical fiber holder having two guide holes for holding the input optical fiber and output optical fiber such that the two optical fibers are placed equidistant from an axis thereof.

Furthermore, preferably, the positioning component whose outer diameter is equal to that of the first convergent rod lens is a package having two guide holes therein for holding the input optical fiber and the output optical fiber such that the two optical fibers are placed equidistant from the axis of the first convergent rod lens.

More preferably, the optical composite module may further include a light-emitting element positioning component for placing the light-emitting element, when being adjusted to a predetermined angle such that the collimated light output from the collimator is focused on the end of the output optical fiber after passing through the optical filter and the first convergent rod lens.

Thus, the light-emitting element is placed at an appropriate position by only adjusting the light-emitting element to the predetermined angle.

For example, the light-emitting element positioning component may include:

a cylindrical holder for holding the first convergent rod lens, an axis of the cylindrical holder coinciding with the axis of the first convergent rod lens; and

a light-emitting element holder whose outer diameter is equal to that of the cylindrical holder, the light-emitting element holder for securing the light-emitting element, and

the light-emitting element holder may lock the light-emitting element so that the collimated light output from the collimator is focused on the end of the output optical fiber when being rotated so as to adjust a relative angle formed with the cylindrical holder to the predetermined angle.

In this case, the light-emitting element is placed at an appropriate position by only rotating the light-emitting element holder for adjusting a relative angle formed with the cylindrical holder.

A third aspect of the present invention is directed to an optical composite module that outputs light modulated by an inputted electric signal and multiplexes the modulated light and light having a plurality of wavelengths output from an input optical fiber for output to an output optical fiber, comprising:

a light-emitting element for emitting the light modulated by the inputted electric signal and focusing the emitted light on a single point;

a first convergent rod lens for converting the light focused by the light-emitting element into collimated light traveling in parallel with an optical axis;

an optical filter placed between the first convergent rod lens and the input and output optical fibers, the optical filter passing light of a predetermined range of wavelengths output from the first convergent rod lens and reflecting light outside of the predetermined wavelengths among light inputted thereinto;

a second convergent rod lens placed between the optical filter and the input and output optical fibers, the second convergent rod lens converting the light output from the input optical fiber into collimated light for inputting into the optical filter, and focusing the collimated light reflected by the optical filter and the collimated light passing through the optical filter on an end of the output optical fiber; and

a positioning component for coinciding an axis of the second convergent rod lens with an axis of the output optical fiber, wherein

an interface surface between the optical filter and the second convergent rod lens is angled so that the collimated light reflected by the optical filter and the collimated light passing through the optical filter are focused on the end of the output optical fiber.

According to the above-described third aspect, the size of the optical module and insertion loss can be reduced. Also, the positioning component ensures coincidence between the optical axis of the second convergent rod lens and an axis of the output optical fiber, whereby a coupling position can be adjusted easily. Furthermore, collimated light traveling in parallel with the optical axis is output from the first convergent rod lens, whereby a coupling position can be adjusted easily.

Preferably, the optical composite may further include:

a first unit including the light-emitting element and the first convergent rod lens; and

a second unit including the optical filter, the second convergent rod lens, and the positioning component, wherein

the first unit and the second unit may be operable to be mated and unmated.

Thus, even if the light-emitting element is deteriorated, it is possible to replace the light-emitting element without interrupting a transmission of the inputted light. Also, the collimated light traveling in parallel with the optical axis is output from the first convergent rod lens, whereby the user does not have to perform high precision positioning when replacing the light-emitting element.

A fourth aspect of the present invention is directed to an optical composite module that outputs light modulated by an inputted electric signal and multiplexes the modulated light and light having a plurality of wavelengths output from an input optical fiber for output to an output optical fiber, comprising:

a light-emitting element for emitting the light modulated by the inputted electric signal and focusing the emitted light on a single point;

a first convergent rod lens for converting the light focused by the light-emitting element into collimated light traveling in parallel with an optical axis;

an optical filter placed between the first convergent rod lens and the input and output optical fibers, the optical filter passing light of a predetermined range of wavelengths output from the first convergent rod lens and reflecting light outside of the predetermined wavelengths among light inputted thereinto;

a second convergent rod lens placed between the optical filter and the input and output optical fibers, the second convergent rod lens converting light output from the input optical fiber into collimated light for inputting into the optical filter, and focusing the collimated light reflected by the optical filter and the collimated light passing through the optical filter on an end of the output optical fiber; and

a positioning component for coinciding an axis of the second convergent rod lens with a center line between the input optical filter and the output optical fiber, wherein

the optical filter is provided with an angled end facing the first convergent rod lens so that the collimated light from the first convergent rod lens is refracted and focused on the end of the output optical fiber.

According to the above-described fourth aspect, the size of the optical module and insertion loss can be reduced. Also, the positioning component ensures coincidence between the optical axis of the second convergent rod lens and the center line between the input optical fiber and the output optical fiber, whereby a coupling position can be adjusted easily. Furthermore, the collimated light traveling in parallel with the optical axis is output from the first convergent rod lens, whereby a coupling position can be adjusted easily.

Preferably, the optical composite module may further include:

a first unit including the light-emitting element and the first convergent rod lens; and

a second unit including the optical filter, the second convergent rod lens, and the positioning component, wherein

the first unit and the second unit may be operable to be mated and unmated.

Thus, even if the light-emitting element is deteriorated, it is possible to replace the light-emitting element without interrupting a transmission of the inputted light. Also, the collimated light traveling in parallel with the optical axis is output from the first convergent rod lens, whereby the user does not have to perform high precision positioning when replacing the light-emitting element.

A fifth aspect of the present invention is directed to an optical composite module that demultiplexes light having a plurality of wavelengths output from an input optical fiber for converting light of a predetermined range of wavelengths into an electric signal and outputting light outside of the predetermined wavelengths to an output optical fiber, comprising:

an optical filter that passes the light falling within a predetermined range of wavelengths to be converted into the electric signal and reflects the light outside of the predetermined wavelengths;

a first convergent rod lens placed between the input and output optical fibers and the optical filter, the first convergent rod lens converting the light output from the input optical fiber into collimated light for inputting into the optical filter, and focusing the collimated light reflected by the optical filter on an end of the output optical fiber;

a second convergent rod lens for focusing the collimated light passing through the optical filter;

a light-receiving element for receiving the light focused by the second convergent rod lens and converting the received light into the electric signal; and

a positioning component for coinciding an optical axis of the first convergent rod lens with an axis of the input optical fiber, wherein

an interface surface between the optical filter and the first convergent rod lens is angled so that the collimated light reflected by the optical filter is focused on the end of the output optical fiber.

According to the above-described fifth aspect, the size of the optical module and insertion loss can be reduced. Also, the positioning component ensures coincidence between the optical axis of the first convergent rod lens and an axis of the input optical fiber, whereby a coupling position can be adjusted easily.

Preferably, the interface surface between the optical filter and the first convergent rod lens is angled so that the collimated light passing through the optical filter travels in parallel with an optical axis.

Thus, the collimated light traveling in parallel with the optical axis is output from the optical filter, whereby a coupling position can be adjusted easily.

More preferably, the optical composite module may include:

a first unit including the light-receiving element and the second convergent rod lens; and

a second unit including the optical filter, the first convergent rod lens, and the positioning component, wherein

the first unit and the second unit may be operable to be mated and unmated.

Thus, even if the light-receiving element is deteriorated, it is possible to replace the light-receiving element without interrupting a transmission of the inputted light. Also, the collimated light traveling in parallel with the optical axis is output from the optical filter, whereby the user does not have to perform high precision positioning when replacing the light-receiving element.

A sixth aspect of the present invention is directed to an optical composite module that demultiplexes light having a plurality of wavelengths output from an input optical fiber for converting light of a predetermined range of wavelengths into an electric signal and outputting light outside of the predetermined wavelengths to an output optical fiber, comprising:

an optical filter that passes the light falling within a predetermined range of wavelengths to be converted into the electric signal and reflects the light outside of the predetermined wavelengths;

a first convergent rod lens placed between the input and output optical fibers and the optical filter, the first convergent rod lens converting the light output from the input optical fiber into collimated light for inputting into the optical filter, and focusing the collimated light reflected by the optical filter on an end of the output optical fiber;

a second convergent rod lens for focusing the collimated light passing through the optical filter on a single point;

a light-receiving element for receiving the light focused by the second convergent rod lens and converting the received light into the electric signal; and

a positioning component for coinciding an optical axis of the first convergent rod lens with a center line between the input optical fiber and the output optical fiber.

According to the above-described sixth aspect, the size of the optical module and insertion loss can be reduced. Also, the positioning component ensures coincidence between the optical axis of the first convergent rod lens and the center line between the input optical fiber and the output optical fiber, whereby a coupling position can be adjusted easily.

Preferably, the optical filter may be provided with an angled end facing the second convergent rod lens so that the collimated light passing through the optical filter travels in parallel with an optical axis.

Thus, the collimated light traveling in parallel with the optical axis is output from the optical filter, whereby a coupling position can be adjusted easily.

More preferably, the optical composite module may include:

a first unit including the light-receiving element and the second convergent rod lens; and

a second unit including the optical filter, the first convergent rod lens, and the positioning component, wherein

the first unit and the second unit may be operable to be mated and unmated.

Thus, even if the light-receiving element is deteriorated, it is possible to replace the light-receiving element without interrupting a transmission of the inputted light. Also, the collimated light traveling in parallel with the optical axis is output from the optical filter, whereby the user does not have to perform high precision positioning when replacing the light-receiving element.

The seventh aspect of the present invention is directed to an optical wavelength demultiplexer that receives a wavelength-multiplexed optical signal having a plurality of wavelengths and demultiplexes the received signal into optical signals on a wavelength basis, comprising:

a wavelength demultiplexing section for demultiplexing the received wavelength-multiplexed optical signal into at least two or more wavelength bands;

an optical signal demultiplexing section provided to each wavelength band for demultiplexing the optical signals in two or more wavelength bands into original optical signals on a wavelength basis, wherein

the optical signal demultiplexer is provided with a plurality of optical composite modules including a light-receiving element that demultiplexes a portion of the inputted optical signals for converting the demultiplexed signal into an electric signal, and outputs other optical signals, wherein

the plurality of optical composite modules are connected in series.

Thus, the optical composite module including the light-receiving element is used, thereby realizing reduction of the device size and minimization of loss. Also, an optical signal is demultiplexed on a wavelength basis, thereby reducing cumulative excess loss in the last stage, the loss caused due to a series connection. Thus, insertion loss required of the optical composite module used in the device of the present invention may be greater than that required of an optical composite module used in the other device.

Preferably, the optical composite module may be any one of the optical composite modules described above.

An eighth aspect of the present invention is directed to an optical wavelength multiplexer that wavelength-multiplexes optical signals having a plurality of wavelengths divided into at least two or more wavelength bands and outputs a wavelength-multiplexed signal, comprising:

an optical signal multiplexing section provided to each wavelength band for multiplexing optical signals having a plurality of wavelengths included in the wavelength band and outputting a multiplexed signal as an optical signal in the wavelength band; and

a wavelength band optical signal multiplexing section for multiplexing the optical signal in the wavelength band output from each optical signal multiplexing section for outputting, wherein

the optical signal multiplexing section is provided with a plurality of optical composite modules including a light-emitting element that outputs an optical signal modulated by an inputted electric signal and multiplexes the modulated optical signal and an inputted optical signal for outputting, and

the plurality of optical composite modules are connected in series.

According to the above-described eighth aspect, the optical composite module including the light-emitting element is used, thereby realizing reduction of the device size and minimization of loss. Also, optical signals are divided into a plurality of wavelength bands for multiplexing, thereby reducing cumulative excess loss in the last stage, the loss caused due to a series connection. Thus, insertion loss required of the optical composite module used in the device of the present invention may be greater than that required of an optical composite module used in the other device.

Preferably, the optical composite module may be any one of the optical composite modules described above.

A ninth aspect of the present invention is directed to an optical composite module manufacturing method for manufacturing an optical composite module that converts convergent light emitted from a light-emitting element into collimated light traveling in parallel with an axis and outputs the converted light, comprising:

a process of removably inserting an optical fiber collimator into a split sleeve from one end thereof, the optical fiber collimator converting light output from an optical fiber whose axis coincides with the optical axis into collimated light traveling in parallel with the optical axis;

a process of inserting a lens holder holding a convergent rod lens into the split sleeve from another end thereof;

a process of fitting the lens holder into an alignment sleeve from an end thereof so as to allow the lens holder to be movable in a direction of an axis;

a process of determining a position of the convergent rod lens so that an output from the optical fiber becomes maximized when the light-emitting element is emitting light;

a process of securing the alignment sleeve and the lens holder, and securing the alignment sleeve and the light-emitting element at the position determined in the process of determining the position of the convergent rod lens; and

a process of pulling out the optical fiber collimator inserted into the split sleeve after the securing process.

According to the above-described ninth aspect, the use of the optical fiber collimator allows the optical composite module to be manufactured easily.

A tenth aspect of the present invention is directed to an optical composite module manufacturing method for an optical composite module that focuses inputted collimated light on a single point and inputs the focused light into a light-receiving element, comprising:

a process of removably inserting an optical fiber collimator into a split sleeve from an end thereof, the optical fiber collimator converting light output from an optical fiber whose axis coincides with the optical axis into collimated light traveling in parallel with the optical axis;

a process of inserting a lens holder holding a convergent rod lens into the split sleeve from another end thereof;

a process of inserting the lens holder into an alignment sleeve from an end thereof so as to allow the lens holder to be movable in a direction of an axis;

a process of determining a position of the convergent rod lens so that an output from the light-receiving element becomes maximized when light is output from the optical fiber;

a process of securing the alignment sleeve and the lens holder, and securing the alignment sleeve and the light-receiving element at the position determined in the process of determining the position of the convergent rod lens; and

a process of pulling out the optical fiber collimator inserted into the split sleeve after the securing process.

According to the above-described tenth aspect, the use of the optical fiber collimator allows the optical composite module to be manufactured easily.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a section view of an optical composite module according to a first embodiment of the present invention;

FIG. 2 is a cross-sectional view of a double-core glass tube 3 mounted in a first package 4;

FIG. 3 is an illustration showing wavelength characteristics of a BPF 5;

FIG. 4 is an exemplarily illustration showing another structure of the first package 4;

FIG. 5 is a section view of an optical composite module according to a second embodiment of the present invention;

FIG. 6 is a section view of an optical composite module according to a third embodiment of the present invention;

FIG. 7 is a section view of an optical composite module according to a fourth embodiment of the present invention;

FIG. 8 is a section view of an optical composite module according to a fifth embodiment of the present invention;

FIG. 9 is a section view of an optical composite module according to a sixth embodiment of the present invention;

FIG. 10 is an exploded perspective view of the optical composite module according to the sixth embodiment of the present invention;

FIG. 11 is an illustration of an end surface B of a second package 96 onto which ends of optical fibers 1a and 1b, a focal point 22a, and a center position 361a are projected;

FIG. 12 is an exemplary illustration of another structure of a third package 36;

FIG. 13 is an illustration of the structures of an optical wavelength multiplexer 50 and an optical wavelength demultiplexer 60 according to a seventh embodiment of the present invention, and the structure of a system employing the above-described devices;

FIG. 14 is a section view showing the structure of an optical composite module according to an eighth embodiment of the present invention;

FIG. 15 is a section view showing the structure of the optical composite module according to the eighth embodiment, which is dismantled into two parts;

FIG. 16 is an exploded perspective view showing a position of a split sleeve within the optical composite module according to the eighth embodiment of the present invention;

FIGS. 17A, 17B, 17C and 17D are illustrations showing a manufacturing method of a semiconductor laser collimator 100 according to the eighth embodiment of the present invention;

FIG. 18 is an illustration showing the structure of an optical system of an optical composite module according to a ninth embodiment of the present invention;

FIG. 19 is an enlarged view showing a reflection optical path and a transmission optical path of the optical system on the optical fiber side of the optical composite module according to the ninth embodiment;

FIG. 20 is an illustration showing the structure of an optical composite module according to the ninth embodiment, the optical composite module including a light-receiving element instead of a light-emitting element;

FIG. 21 is an illustration showing the structure of a conventional interference filter-based optical multiplexer; and

FIG. 22 is an illustration showing the structure of an optical module disclosed in Japanese Patent Laid-Open Publication No. H11-242130.

### DESCRIPTION OF THE PREFERRED EMBODIMENTS

(First Embodiment)

FIG. 1 is a section view of an optical composite module according to a first embodiment of the present invention. An optical composite module described in the present embodiment is an optical composite module that receives an optical signal with wavelength λ4 from among multiplexed signals with wavelengths λ1 to λ8. A dotted line in the drawing represents a stream of light. In FIG. 1, the optical composite module includes an input optical fiber 1a, an output optical fiber 1b, a convergent rod lens 2, a double-core glass tube 3, a first package 4, a BPF 5, a light-receiving element 6, a second package 9, and a refractive index matching layer 10.

The input optical fiber 1a transmits the multiplexed optical signals with wavelengths λ1 to λ8. The output optical fiber 1b transmits the multiplexed optical signals with wavelengths λ1 to λ3 and λ5 to λ8 output from the convergent rod lens 2.

The convergent rod lens 2 is a rod lens whose refractive index is the highest on the optical axis but becomes lower with distance therefrom. The size of the convergent rod lens 2 is 0.25 pitches. Here, a pitch is a meandering cycle of a light beam within the lens. With the characteristics of the above-described refraction index and size, the convergent rod lens 2 converts light output from the input optical fiber 1a into collimated light for outputting, and focuses the collimated light reflected by the BPF 5 on a single point on one end of the output optical fiber 1b.

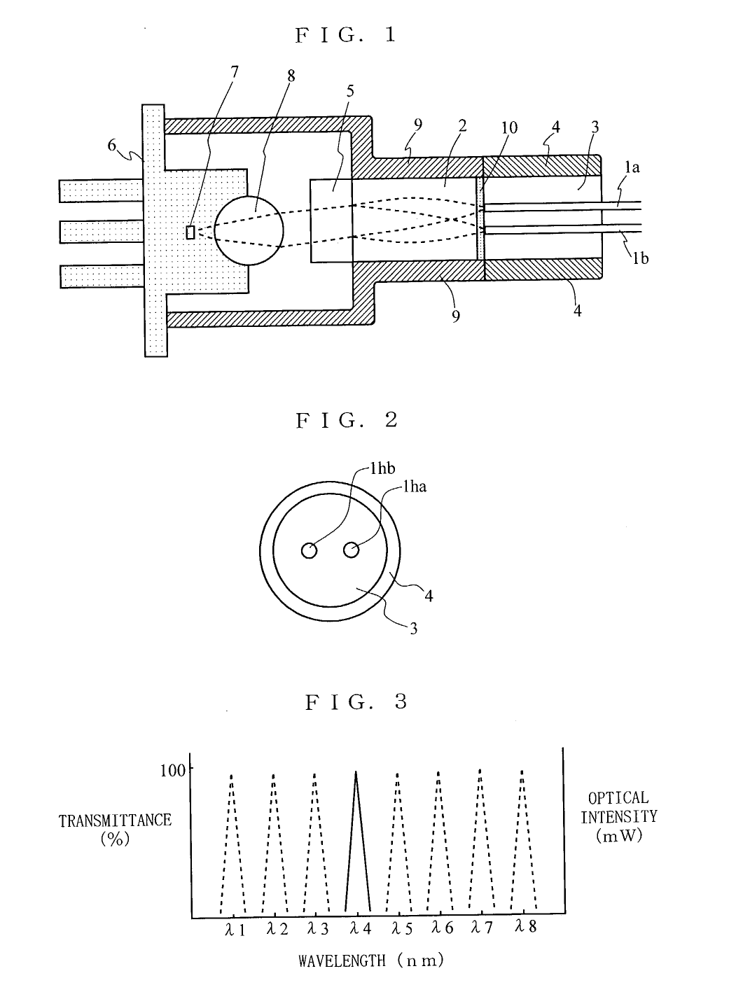

The double-core glass tube 3 is a glass tube having two guide holes for inserting the input optical fiber 1a and the output optical fiber 1b thereinto and holding these optical fibers. The double-core glass tube 3 is mounted in the first package 4. FIG. 2 is a cross-sectional view of the double-core glass tube 3 mounted in the first package 4. The double-core glass tube 3 has a guide hole 1ha for inserting the input optical fiber 1a thereinto, and a guide hole 1hb for inserting the output optical fiber 1b thereinto. The double-core glass tube 3 and the convergent rod lens 2 are equal in outer diameter. The axis of the double-core glass tube 3 coincides with the center line between the guide holes 1ha and 1hb. That is, the input optical fiber 1a and the output optical fiber 1b are placed equidistant from the optical axis of the convergent rod lens 2, and the optical axis coincides with the center line between the input optical fiber 1a and the output optical fiber 1b.

The refractive index matching layer 10 reduces Fresnel reflection loss produced at the interface point at the end of the optical fiber and the air.

FIG. 3 is an illustration showing wavelength characteristics of a BPF 5. The BPF 5 passes light with wavelength λ4 but reflects light with wavelengths λ1 to λ3 and λ5 to λ8.

The light-receiving element 6 is provided with a light-receiving chip 7 and a ball lens 8. The ball lens 8 focuses the collimated light output from the BPF 5 on the light-receiving chip 7. The light-receiving chip 7 converts the received optical signal into an electric signal, and outputs the converted signal to a terminal connected to the light-receiving element 6. The light-receiving element 6 is placed at the position where the electric signal converted from the received optical signal is output at the optimum level.

The first package 4 is a cylindrical package for mounting the double-core glass tube 3 therein. The second package 9 is a T-shaped package with smaller and greater cylindrical holes for mounting the convergent rod lens 2, the BPF 5, and the light-receiving element 6 therein. The first package 4 and the smaller cylindrical hole of the second package 9 are equal in outer diameter. The first package 4 and the second package 9 are made of metal such as SUS 304. The end of the smaller cylindrical hole of the second package 9 and the end of the first package 4 on the side of the refractive index matching layer 10 are welded by a YAG weld so as to coincide the outer edge of the convergent rod lens 2 with that of the double-core glass tube 3 (that is, so as to coincide the outer edge of the smaller cylindrical hole of the second package 9 with that of the first package 4). The second package 9 and the first package 4 are positioning components for coinciding the optical axis of the convergent rod lens 2 and the center line between the input optical fiber 1a and the output optical fiber 1b.

Next, a manufacturing process of the above-described optical composite module is described in detail.

First, the BPF 5 is bonded to an end surface of the convergent rod lens 2 by using an epoxy resin or a UV cure resin so that an end surface of the BPF 5 coincides with the focal point of the convergent rod lens 2. Note that the BPF 5 maybe evaporated onto the end surface of the convergent rod lens 2.

Then, the convergent rod lens 2 is implanted in the smaller cylindrical hole of the second package 9 so that the other end surface of the convergent rod lens 2 lies below the end surface of the second package 9 by around 10 μm. Then, the double-core glass tube 3, into which the input optical fiber 1a and the output fiber 1b each having a polished end are inserted, is mounted in the first package 4 so that an end surface of the first package 4 coincides with an end surface of the double-core glass tube 3.

Then, a light source with wavelength λ1 is connected to the other end of the input optical fiber 1a, and an optical power meter is connected to the other end of the output optical fiber 1b. A refractive index matching material is then applied to the sunken end surface of the convergent rod lens 2 so as to form the refractive index matching 10. Then, the first package 4 and the second package 9 are each secured on an adjustment jig so that the outer edge of the convergent rod lens 2 coincides with that of the double-core glass tube 3. If the first package 4 is brought close to the second package 9 when those two packages are each secured to the adjustment jig, the refractive index matching layer material comes into contact with the polished ends of the input optical fiber 1a and the output optical fiber 1b. As a result, an output value can be obtained from the optical power meter connected to the output optical fiber 1b, thereby determining whether the light is output from the optical fiber 1b or not. Then, with reference to the optical power meter, the first package 4 and the second package 9 are each fine adjusted in the direction of the optical axis while being faced to each other for determining a position where a connection therebetween becomes the optimum. When the optimum position is determined, a YAG laser is applied to the contact surface between the first package 4 and the second package 9 so as to weld those two packages. The optimum position is determined when the focal point of the convergent rod lens 2 coincides with the polished ends of the input optical fiber 1a and the output optical fiber 1b.

Then, the light-receiving element 6 is removably attached to the greater cylindrical hole of the second package 9. Then, the light source with wavelength λ4 is connected to the input optical fiber 1a so as to locate a position where the light-receiving chip receives any light. In order to maximize the output of the electric light output from the light-receiving element 6 in the proximity of the above-described position, the position of the light-receiving element 6 is then fine adjusted on a plane normal to the optical axis of the convergent rod lens 2. If the maximum output level is obtained, the light-receiving element 6 is welded with the second package 9 by the YAG laser. It is not of particular difficulty to adjust the position on the plane normal to the optical axis due to the size of the light-receiving element 6 (that is, the light-receiving element 6 is larger than the other components). The maximum output level can be obtained at the position where the ball lens 8 focuses the collimated light from the BPF 5 on the light-receiving chip 7. This is the process for making the above-described optical composite module.

Next, an operation of the above-described optical composite module is described. Light with wavelengths λ1 to λ8 output from the input optical fiber 1a pass the refractive index matching layer 10 without Fresnel reflection, and enter the convergent rod lens 2. The light with wavelengths λ1 to λ8 is then converted into collimated light, and enters the BPF 5. The BPF 5 passes the light with wavelength λ4 but reflects the light with wavelengths λ1 to λ3 and λ5 to λ8. The light with wavelengths λ1 to λ3 and λ5 to λ8 reflected by the BPF 5 are focused on the polished-end of the output optical fiber 1b after passing through the convergent rod lens 2 again, and coupled into the output optical fiber 1b. The focal point and the input point of an optical signal output from the input optical fiber 1a are symmetric with respect to the optical axis of the convergent rod lens 2. As aforementioned, the center line between the input optical fiber 1a and the output optical fiber 1b coincides with the optical axis of the convergent rod lens 2. That is, the focal point coincides with the polished-end of the output optical fiber 1b. Therefore, the light with wavelengths λ1 to λ3 and λ5 to λ8 are coupled into the output optical fiber 1b.

At the same time, the collimated light with wavelength λ4 passing through the BPF 5 is focused on the light-receiving chip 7 by the ball lens 8 of the light-receiving element 6, and converted into an electric signal.

As described above, the optical composite module according to the first embodiment includes the light-receiving element 6, thereby realizing reduction of the device size and insertion loss.

Furthermore, the convergent rod lens 2 and the double-core glass tube 3 are equal in outer diameter, and the second package 9 and the first package 4 are also equal in outer diameter so that the optical axis of the convergent rod lens 2 coincides with the center line between the input and output optical fibers, thereby allowing positioning to be performed with ease and enabling easy adjustment of the optical axis for ensuring coupling between the light and the optical fiber. Thus, it is possible to provide an optical composite module that can be manufactured easily.

Still further, the use of the light-receiving element 6 receiving the collimated light by using the ball lens allows more light to be received from the BPF 5. The received light is focused somewhere on the light-receiving chip 7, whereby angle adjustment of the light-receiving element 6 does not have to be performed.

Furthermore, the optical composite module according to the present embodiment has an advantage in mountability due to the configuration of the input and output optical fibers connected to the same side thereof.

Note that the size of the convergent rod lens 2 is assumed to be 0.25 pitches, but that the size is not restricted thereto. As long as the polished-end of the optical fiber is placed at the focal point on the lens end, the size of the convergent rod lens 2 may be, for example, 0.23 pitches.

Also, it is possible to provide an optical composite module that can receive only light with an arbitrary wavelength band if the wavelength characteristics of the BPF 5 is changed.

The convergent rod lens 2 and the double-core glass tube 3 are assumed to be equal in outer diameter in the present embodiment. However, if the first package 4 and the second package 9 are at least equal in outer diameter, it is possible to perform positioning with ease.

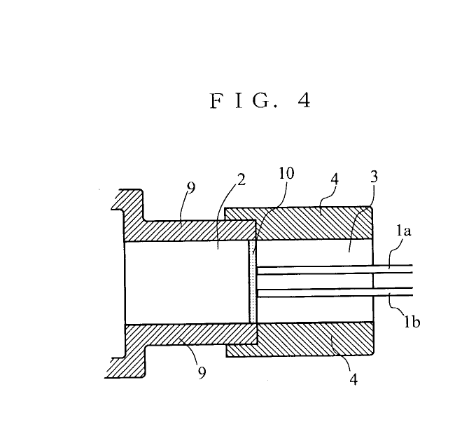

Also, the shape of the first package 4 mounting the double-core glass tube 3 therein is not restricted to that described in FIG. 1. FIG. 4 is an exemplarily illustration showing another structure of the first package 4. As shown in FIG. 4, an entry point of the first package 4 may be L-shaped so as to hold the end of the smaller cylindrical hole of the second package 9. The inner diameter of the sunken end of the first package 4 coincides with the outer diameter of the smaller cylindrical hole of the second package 9. Thus, if the end of the smaller cylindrical hole of the second package 9 is inserted into the sunken end of the first package 4, the optical axis of the convergent rod lens 2 coincides with the center line between the input optical fiber 1a and the output optical fiber 1b. As described above, as long as a positioning component that ensures coincidence between the optical axis of the convergent rod lens 2 and the center line between the input optical fiber 1a and the output optical fiber 1b is used, the shape thereof is not restricted.

(Second Embodiment)

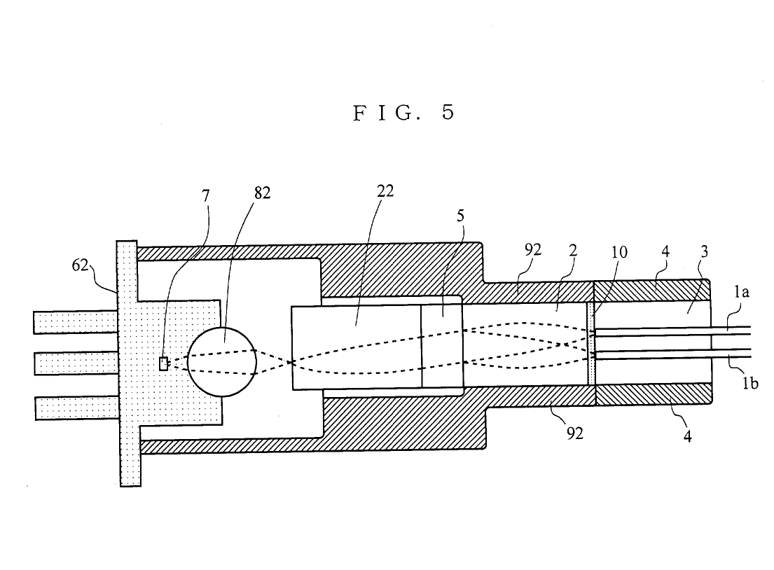

FIG. 5 is a section view of an optical composite module according to a second embodiment of the present invention. In FIG. 5, the components that function in similar manners to their counterparts of the optical composite module according to the first embodiment are denoted by like numerals, with the descriptions thereof omitted.

The optical composite module according to the second embodiment includes a light-receiving element 62 receiving dispersed light and converting the received light into an electric signal, a convergent rod lens 22 placed between the BPF 5 and the light-receiving element 62, and a second package 92.

The size of the convergent rod lens 22 is 0.25 pitches. The 0.25 pitch-sized convergent rod lens 22 focuses the collimated light passing through the BPF 5 on a single point on the lens end, for the same reason described in the first embodiment.

The light-receiving element 62 is provided with a ball lens 82, which is a finite lens that focuses light with an expanded beam. The ball lens 82 focuses the dispersed light from the convergent rod lens 22 on the light-receiving chip 7. The light-receiving element 62 is a widely used, lens-equipped light-receiving element for general purpose use. The light-receiving element 62 is placed at the position where the light from the convergent rod lens 22 is received and output therefrom at the maximum output level.

The second package 92 is a T-shaped package for housing the convergent rod lens 2, the BPF 5, the convergent rod lens 22, and the light-receiving element 62. The BPF 5, having one end bonded to an end of the convergent rod lens 2 and the other end bonded to an end of the convergent rod lens 22 with an epoxy resin, etc., is mounted in the smaller cylindrical hole of the second package 92. The refractive index matching layer 10 is formed at the other end of convergent rod lens 2, where the second package 92 is welded with the first package 4 placed at the optimum position, which includes the double-core glass tube 3, the input optical fiber 1a, and the output optical fiber 1b. In the greater cylindrical hole of the second package 92, the light-receiving element 62 is placed at the position where an output level becomes maximized. Then, the light-receiving element 62 is welded with the second package 92.

Next, an operation of the above-described optical composite module is described.

Light with wavelengths λ1 to λ8 output from the input optical fiber 1a is converted into collimated light by the convergent rod lens 2, and enters the BPF 5. The BPF 5 passes the light with wavelength λ4 but reflects the light with wavelengths λ1 to λ3 and λ5 to λ8. The light with wavelengths λ1 to λ3 and λ5 to λ8 reflected by the BPF 5 are coupled into the output optical fiber 1b as is the case with the first embodiment.

On the other hand, the collimated light with wavelength λ4 passing through the BPF 5 is focused by the convergent rod lens 22 on the lens end thereof. The light focused on the lens end travels again with a beam divergence corresponding to the NA (numerical aperture) of the optical fiber, and enters the ball lens 82. The light entering the ball lens 82 is then focused on the light-receiving chip 7, and converted into an electric signal.

As described above, the lens-equipped light-receiving element 62 for general purpose use is used in the second embodiment. Thus, it is possible to provide the optical composite module at low cost.

Also, it is only necessary to bond one end of the BPF 5 to an end of the convergent rod lens 2 and the other end of the BPF 5 to an end of the convergent rod lens 22. Thus, a high precision angle adjustment of such two lenses is not needed.

Note that, in the second embodiment, the size of the convergent rod lens 22 is assumed to be 0.25 pitches, but that is not restricted thereto as long as the convergent rod lens 22 focuses light in an inward or outward direction, and outputs dispersed light.

(Third Embodiment)

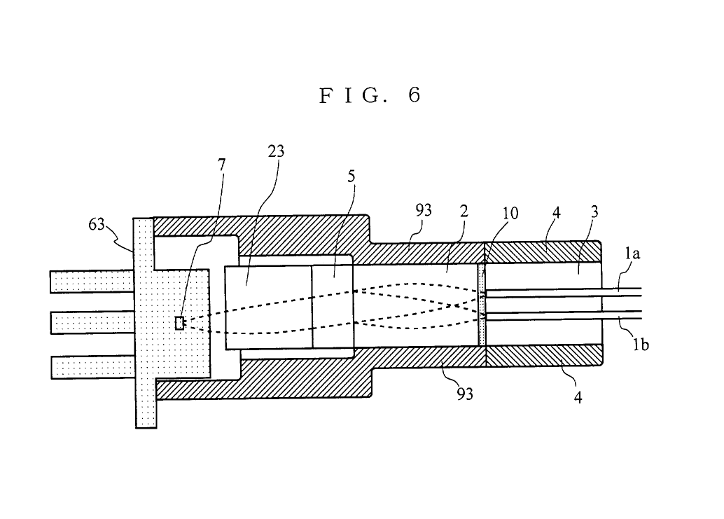

FIG. 6 is a section view of an optical composite module according to a third embodiment of the present invention. In FIG. 6, the components that function in similar manners to their counterparts of the optical composite module according to the first embodiment are denoted by like numerals, with the descriptions thereof omitted.

The optical composite module according to the third embodiment includes a light-receiving element 63 having no ball lens, a convergent rod lens 23 placed between the light-receiving element 63 and the BPF 5, and a second package 93. The convergent rod lens 23 is bonded to an end of the BPF 5.

The convergent rod lens 23 is a rod lens whose pitch is smaller than 0.25 (for example, 0.23 pitches), and whose refractive index is the highest on the optical axis but becomes lower with distance therefrom. The focal point of the convergent rod lens 23 is located beyond the lens end. The light-receiving element 63 is not provided with a ball lens. The light-receiving element 63 is placed so that the light-receiving chip 7 is located at the focal point of the convergent rod lens 23.

The second package 93 is a T-shaped package for housing the convergent rod lens 2, the BPF 5, the convergent rod lens 23, and the light-receiving element 63. The BPF 5, having one end bonded to an end of the convergent rod lens 2 and the other end bonded to an end of the convergent rod lens 23 with an epoxy resin, etc., is mounted in the smaller cylindrical hole of the second package 93. The first package 4 mounting the double-core glass tube 3 and the optical fibers therein is welded with the second package 93 at the optimum position. In the greater cylindrical hole of the second package 93, the light-receiving element 63 is placed at the position where an output level becomes maximized, that is, a position where the light-receiving chip 7 is located at the focal point of the convergent rod lens 23. Then, the light-receiving element 63 is welded with the second package 93.

The light with wavelength λ4 passing through the BPF 5 is focused by the convergent rod lens 23 on a single point located beyond the lens end. The light-receiving chip 7 is also placed at this focal point. Thus, the optical signal is converted into an electric light by the light-receiving chip 7. The light with wavelengths λ1 to λ3 and λ5 to λ8 is coupled into the output optical fiber 1b in similar manners as in the case of the first embodiment.

A light-receiving element having no ball lens can detect a glimmer of light even when the optical axis is misaligned. Once the light can be detected, it is only necessary to adjust an output level to become maximized. Thus, positioning can be performed with ease. On the other hands, in the case of a light-receiving element having a ball lens, even when the ball lens receives a glimmer of light, the light-receiving chip does not necessarily receive the light if the optical axis is misaligned. As a result, it is difficult to adjust an output level to become maximized in the case of the light-receiving element having a ball lens.

Thus, in the third embodiment, it is possible to provide the optical composite module that allows the optimum position of a focal point on the light-receiving element to be adjusted easier compared to the case where the light-receiving element having a ball lens is used.

(Fourth Embodiment)

In the first to third embodiments, the receiving optical composite module for demultiplexing an optical signal has been described. In a fourth embodiment, a transmitting optical composite module for multiplexing an optical signal for output is described.

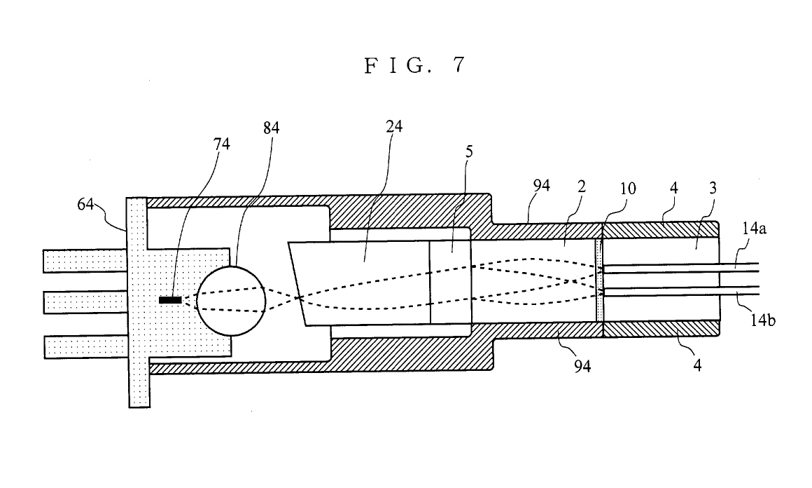

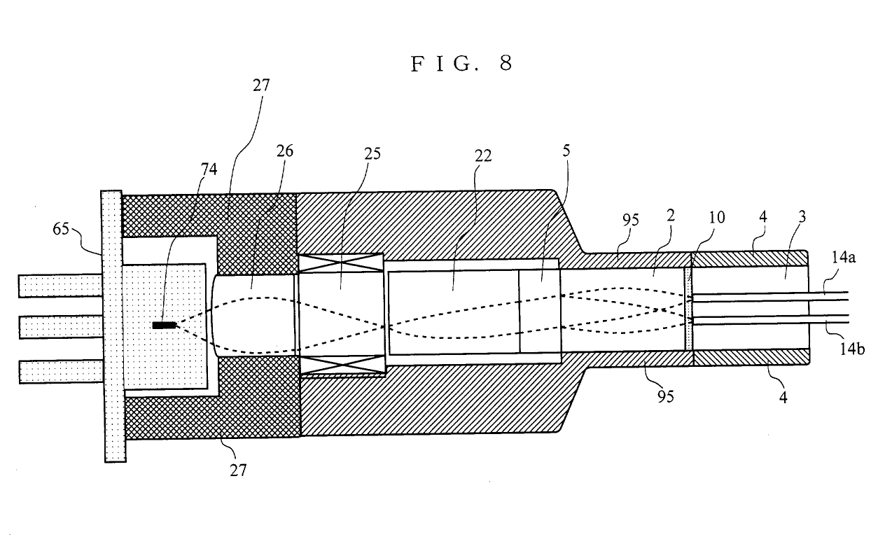

FIG. 7 is a section view of an optical composite module according to the fourth embodiment of the present invention. In FIG. 7, the components that function in similar manners to their counterparts of the optical composite module according to the first embodiment are denoted by like numerals, with the descriptions thereof omitted.

The optical composite module according to the fourth embodiment includes an output optical fiber 14a, an input optical fiber 14b, a convergent rod lens 24, a light-emitting element 64, and a second package 94.

The input optical fiber 14b transmits light signals with wavelengths λ1 to λ3 and λ5 to λ8. The output optical fiber 14a transmits the multiplexed light signals with wavelengths λ1 to λ8. As is the case with the first embodiment, a center line between the input optical fiber 14b and the output optical fiber 14a coincides with the optical axis of the convergent rod lens 2. That is, the input optical fiber 14b and the output optical fiber 14a are placed so as to be symmetric with respect to the optical axis.

The one end of the convergent rod lens 24 is bonded to the BPF 5 with an epoxy resin, etc., and the other end thereof is polished and angled at 8 degrees. The convergent rod lens 24 is a rod lens whose refractive index is the highest on the optical axis but becomes lower with distance therefrom as in the case of the convergent rod lens 2. The light-emitting element 64 is provided with a light-emitting chip 74 and a ball lens 84. The light-emitting chip 74 outputs an optical signal modulated by an inputted electric signal. The ball lens 84 focuses light emitted from the light-emitting chip 74, and inputs the focused light into the angled end surface of the convergent rod lens 24. The light-emitting element 64 is placed so that the light emitted therefrom is focused on the angled end surface of the convergent rod lens 24, and the focused light is coupled into the output optical fiber 14a after passing through the convergent rod lens 24, the BPF 5, and the convergent rod lens 2.

The second package 94 is a T-shaped package for housing the convergent rod lens 2, the BPF 5, the convergent rod lens 24, and the light-emitting element 64. The BPF 5, having one end bonded to an end of the convergent rod lens 2 and the other end bonded to an end of the convergent rod lens 24 with an epoxy resin, etc., is mounted in the smaller cylindrical hole of the second package 94. The first package 4 mounting the double-core glass tube 3 and the input optical fiber 14b and the output optical fiber 14a therein is welded with the second package 94 at the optimum position. In the greater cylindrical hole of the second package 94, the light-emitting element 64 is placed so that power of the light output from the output optical fiber 14a becomes maximized. The light-emitting element 64 is then welded with the second package 94. The position of the light-emitting element 64 may be adjusted on the plane normal to the optical axes of the convergent rod lenses 2 and 24.

Next, an operation of the above-described optical composite module is described.

Light with wavelengths λ1 to λ3 and λ5 to λ8 output from the input optical fiber 14b is converted into collimated light by the convergent rod lens 2, and enters the BPF 5. The light entering the BPF 5 is reflected by the BPF 5. The light with wavelengths λ1 to λ3 and λ5 to λ8 reflected by the BPF 5 passes through the convergent rod lens 2 again, and is coupled into the output optical fiber 14a.

Light with wavelength λ4 emitted from the light-emitting chip 74 is focused by the ball lens 84, and enters the convergent rod lens 24. The light with wavelength λ4 entering the convergent rod lens 24 is converted into collimated light. The converted light is focused by the convergent rod lens 2 after passing through the BPF 5, and coupled into the output optical fiber 14a. Thus, the light with wavelengths λ1 to λ3 and λ5 to λ8 and the light with wavelength λ4 are multiplexed.

As described above, in the fourth embodiment, it is possible to provide the transmitting optical composite module that can realize reduction of size and insertion loss due to the emitting-device built therein.

Also, the convergent rod lens 2 and the double-core glass tube 3 are equal in outer diameter, and the second package 94 and the first package 4 are equal in outer diameter so that the optical axis of the convergent rod lens 2 coincides with the center line between the input optical fiber 14b and the output optical fiber 14a. AS a result, adjustment of the optical axis can be easily performed for coupling the emitted light into the optical fiber. Thus, it is possible to provide the transmitting optical composite module that can be manufactured easily.

Furthermore, the convergent rod lenses 2 and 24 are each previously bonded to the end surface of the BPF 5. Thus, a high precision angle adjustment of such two lenses is not needed.

Still further, the optical composite module according to the present embodiment has an advantage in mountability due to the configuration of the input and output optical fibers connected to the same side thereof.

Also, the end of the convergent rod lens 24 is angled, thereby eliminating back reflection of the light emitted from the light-emitting element 64 and minimizing noise occurring when the reflected light enters the light-emitting chip 74 again. As a result, it is possible to provide a stable transmitting optical composite module.

It is also possible to provide a transmitting optical composite module that can multiplex optical signals with arbitrary wavelength bands by changing a wavelength of light emitted from the light-emitting element 64 and wavelength characteristics of the BPF 5.

Note that the angle of the angled end of the convergent rod lens 24 is assumed to be 8 degrees in the fourth embodiment, but that is not restricted thereto as long as the reflected light has no adverse effect.

Note that, in the fourth embodiment, the end of the convergent rod lens 24 is assumed to be angled in order to eliminate back reflection, but the lens end may not be angled as long as an AR coating (antireflection coating), etc., is additionally applied to the end surface of the lens.

Also, the shapes of the first package 4 and the second package 94 are not restricted to those described above as long as the optical axis of the convergent rod lens 2 coincides with the center line between the input optical fiber 14b and the output optical fiber 14a.

(Fifth Embodiment)

In a fifth embodiment, a transmitting optical composite module is described. FIG. 8 is a section view of the optical composite module according to the fifth embodiment of the present invention. In FIG. 8, the components that function in similar manners to their counterparts of the optical composite module according to the second and fourth embodiments are denoted by like numerals, with the descriptions thereof omitted.

In FIG. 8, the optical composite module includes a rounded-end convergent rod lens 26, an optical isolator 25, a second package 95, a third package 27, and a light-emitting element 65. The light-emitting element 65 is not provided with a ball lens. The rounded-end convergent rod lens 26 focuses light emitted from the light-emitting chip 74 on the end surface of the convergent rod lens 22. The rounded-end convergent rod lens 26 can enlarge NA and increase the amount of light to be received due to the rounded tip of the lens.

The optical isolator 25, which passes the light from the rounded-end convergent rod lens 26 but does not pass the light from the convergent rod lens 22, is placed between the rounded-end convergent rod lens 26 and the convergent rod lens 22. Thus, the light reflected at the end surface of the convergent rod lens 22 does not enter the light-emitting chip 74.

The second package 95 is a T-shaped package for mounting the BPF 5 having one end bonded to an end of the convergent rod lens 2 and the other end bonded to an end of the convergent rod lens 22 with an epoxy resin, etc., in a cylindrical hole on the one side, and mounting the optical isolator 25 in a cylindrical hole on the other side. The third package 27 is a cylindrical package for mounting the rounded-end convergent rod lens 26 in the smaller cylindrical hole and securing the light-emitting element 65 in the greater cylindrical hole.

The second package 95 housing the convergent rod lens 2, the BPF 5, the convergent rod lens 22, and the optical isolator 25 are welded with the first package 4 housing the double-core glass tube 3, the input optical fiber 14b, and the output optical fiber 14a at the optimum position. The rounded-end convergent rod lens 26 is mounted in the third package 27 so that light emitted from the light-emitting element 65 is focused on the end surface of the convergent rod lens 22. The second package 95 and the third package 27 housing the rounded-end convergent rod lens 26 are welded to each other. The position of the light-emitting element 65 is adjusted on a plane normal to the optical axis of the convergent rod lenses 2 and 22 and the rounded-end convergent rod lens 26 so that the light emitted therefrom is coupled into the output optical fiber 14a. The light-emitting element 65 is then welded with the third package 27.

The light emitted from the light-emitting chip 74 is focused on the end surface of the convergent rod lens 22, and enters the convergent rod lens 22. The light entering the convergent rod lens 22 is coupled into the output optical fiber 14a as in the case of the fourth embodiment. The light output from the input optical fiber 14b is coupled into the output optical fiber 14a after following the same process as in the case of the fourth embodiment.

As described above, in the fifth embodiment, the optical isolator 25 prevents the light reflected by the convergent rod lens 22 from entering the light-emitting chip 74, thereby minimizing noise occurring when the reflected light enters the light-emitting chip 74. As a result, it is possible to provide a stable transmitting optical composite module.

(Sixth Embodiment)

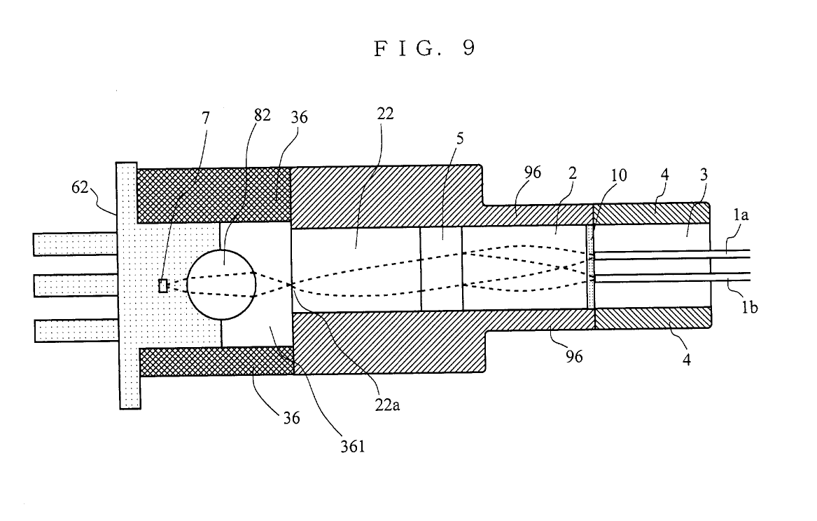

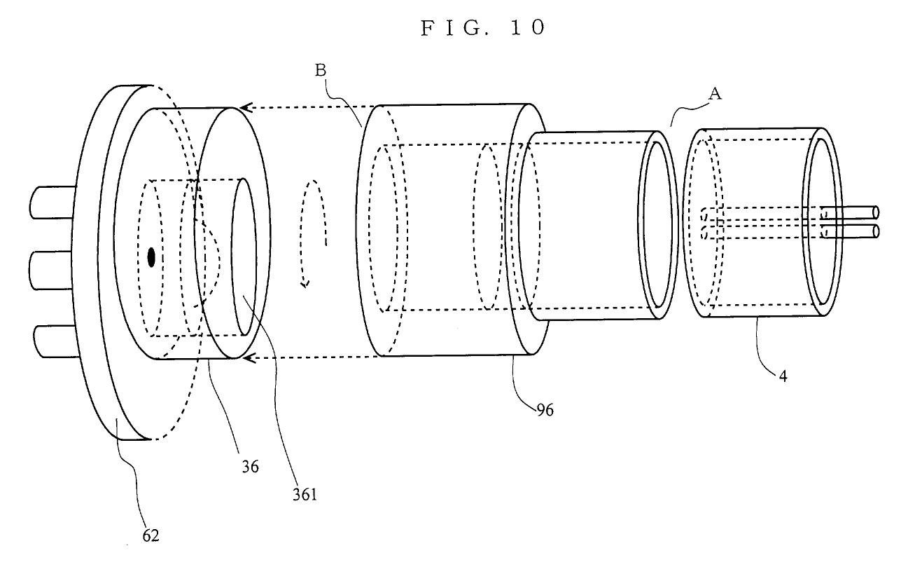

The structure of an optical composite module according to a sixth embodiment allows positioning of the light-receiving element 62 to be performed easier compared to that performed in the optical composite module according to the second embodiment. FIG. 9 is a section view of the optical composite module according to the sixth embodiment. FIG. 10 is an exploded perspective view of the optical composite module according to the sixth embodiment. In FIGS. 9 and 10, the components that function in similar manners to their counterparts of the optical composite module according to the second embodiment are denoted by like numerals, with the descriptions thereof omitted. In FIG. 9, the optical composite module includes a second package housing the BPF 5 having one end bonded to an end of the convergent rod lens 2 and the other end bonded to an end of the convergent rod lens 22 with an epoxy resin, etc., and a third package 36 for housing the light-receiving element 62.

The second package 96 is a T-shaped cylinder, and the smaller cylindrical hole thereof is welded with the first package 4. As is the case with the second embodiment, the smaller cylindrical hole of the second package 96 and the first package 4 are equal in outer diameter. The third package 36 is welded with end surface B of the greater cylindrical hole of the second package 96. The third package 36 and the greater cylindrical hole of the second package 96 are equal in outer diameter.

The third package 36 has an off-center housing hole 361 for housing the tip of the light-receiving element 62. The inner diameter of the housing hole 361 coincides with the outer diameter of the light-receiving element 62. The center of the housing hole 361 coincides with a focal point 22a on the end surface of the convergent rod lens 22, on which light with wavelength λ4 is focused by the convergent rod lens 22. The light-receiving chip 7 is placed on the center line of the housing hole 361 at a position apart from the end of the convergent rod lens 22 by the focal length.

The focal point 22a of the convergent rod lens 22 is clearly defined as a predetermined position because the input optical fiber 1a and the output optical fiber 1b are placed equidistant from the optical axis at a predetermined spacing. In general, the focal point 22a is placed on a position opposed to the output optical fiber 1b. Thus, the center position of the housing hole 361 in the third package 36 can be determined. The housing hole 361 can be formed around the above-described center position. The tip of the light-receiving element 62 is inserted into the housing hole 361, and the light-receiving element 62 is secured to the third package 36 by welding, etc.

When the third package 36 is secured to the second package 96, it is only necessary to rotate the third package 36 with its outer edge being kept aligned with that of the second package 96 until the center of the housing hole 361 of the third package 36 coincides with the focal point 22a of the convergent rod lens 22. The third package 36 and the second package 96 are positioning components for positioning of the light-receiving element.

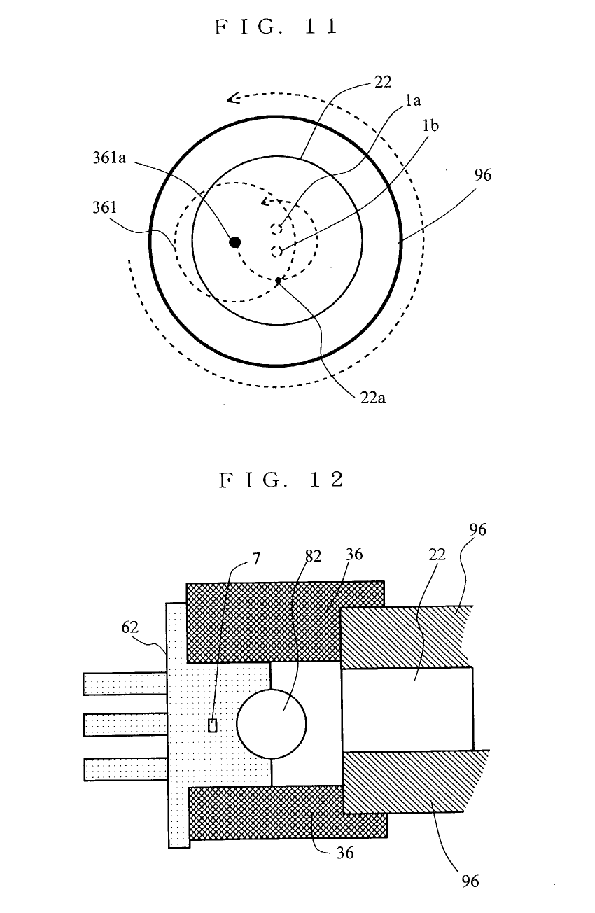

FIG. 11 is an illustration of an end surface B of the second package 96 onto which the ends of the optical fibers 1a and 1b, a focal point 22a, and a center position 361a are projected. With reference to FIG. 11, positioning of the third package 36 will be described in detail. Note that, in FIG. 11, the focal point 22a is displaced from a position of the end of the optical fiber 1b, but the focal point 22a and the end of the optical fiber 1b are generally opposed to each other. Thus, the focal point 22a coincides with the position of the end of the optical fiber 1b. If the third package 36 is rotated with its outer edge being kept aligned with that of the second package 96 so as to coincide the focal point 22a, which is placed at the end surface of the convergent rod lens 22, with the center position 361a of the housing hole 361, the center position 361a circles around the center between the ends of the input optical fiber 1a and the output optical fiber 1b. When the center position 361a falls on the focal point 22a, the output level of the light-receiving element 62 becomes maximized. Thus, if the third package 36 and the second package 96 are welded with each other when the center position 361a falls on the focal point 22a, the light-receiving chip 7 can be placed at the optimum position. That is, the light-receiving chip 7 can be placed at the optimum position when the relative angle that the third package 36 forms with the second package 96 becomes a predetermined angle.

As described above, in the sixth embodiment, the third package 36 housing the light-receiving element 62 and the greater cylindrical hole of the second package 96 are equal in outer diameter so as to adjust the relative angle that the third package 36 forms with the second package 96, thereby enabling the light-receiving chip 7 to be placed at the optimum position. Thus, it is possible to adjust the position of the light-receiving element 62 with greater ease, thereby further facilitating manufacturing of the optical composite module.

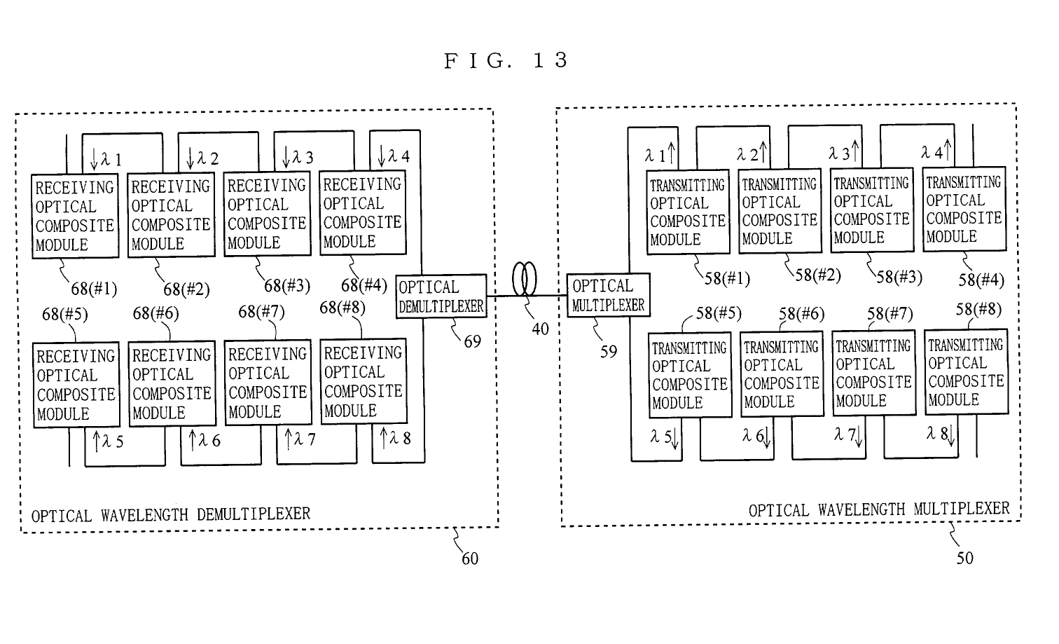

Note that the shapes of the third package 36 and the second package 96 are not restricted to those described above. For example, as shown in FIG. 12, an entry point of the third package 36 may be L-shaped so as to hold an end of the second package 96. Also in this case, the relative angle that the third package 36 forms with the second package 96 can be adjusted only by rotating the third package 36. Thus, it is possible to place the light-receiving chip 7 at an appropriate angle.

The structure described above allows easy positioning of the optical composite module according to the second embodiment. However, also in the above-described other embodiments, the optical composite module can be manufactured easier if a package that secures a light-receiving element or a light-emitting element therein is used.

Specifically, the optical composite module according to the first embodiment (see FIG. 1) may include an additional package as following: a package having a cylindrical hole whose axis coincides with the center line of the collimated light emitted from the BPF 5 for housing the light-receiving element 6. The package and the second package 9 are equal in outer diameter. By using the additional package described above, positioning of the light-receiving element 62 can be performed easily.

Also, the optical composite module according to the third embodiment (see FIG. 6) may include an additional package as following: a package having a cylindrical hole for housing the light-receiving chip 7, the cylindrical hole on whose axis a focal point of the convergent rod lens 23 is placed, the package whose outer diameter coincides with that of the second package 93. By using the above-described additional package, positioning of the light-receiving element 63 can be performed easily.

Furthermore, the optical composite module according to the fourth embodiment (see FIG. 7) may include an additional package as following: a package having a cylindrical hole for securing the light-emitting element 64, the cylindrical hole on whose axis an input point on the end surface of the convergent rod lens 24 is placed, the package whose outer diameter coincides with that of the second package 94. By using the above-described additional package, positioning of the light-emitting element 64 can be performed easily.

Still further, the optical composite module according to the fifth embodiment (see FIG. 8) may include an additional package as following: a package having a cylindrical hole for securing the light-emitting element 65, the cylindrical hole on whose axis an input point on the end surface of the rounded-end convergent rod lens 26 is located. The package and the third package 27 are equal in outer diameter. By using the above-described additional package, positioning of the light-emitting element 65 can be performed easily.

(Seventh Embodiment)

In a seventh embodiment, a device for optical wavelength multiplexing and a device for optical wavelength demultiplexing of light signals with wavelengths λ1 to λ8 are described. FIG. 13 is an illustration of the structures of an optical wavelength multiplexer 50 and an optical wavelength demultiplexer 60 according to the seventh embodiment of the present invention, and the structure of a system employing the above-described devices. In FIG. 13, the system includes the optical wavelength multiplexer 50, an optical fiber 40, and the optical wavelength demultiplexer 60.

The optical wavelength multiplexer 50 multiplexes optical signals with wavelengths λ1 to λ8 and outputs the multiplexed signal. The optical fiber 40 transmits the optical signal output from the optical wavelength multiplexer 50, and inputs the output signal into the optical wavelength demultiplexer 60. The optical wavelength demultiplexer 60 demultiplexes the multiplexed optical signal into the original optical signals with wavelengths λ1 to λ8 transmitted over the optical fiber 40.

The optical wavelength multiplexer 50 includes an optical multiplexer 59 and eight transmitting optical composite modules 58. Each optical composite module 58 outputs an optical signal with a different wavelength, and the optical composite module that outputs an optical signal with a wavelength λi (i=1 to 8) is denoted by a reference number 58 (#i). Hereinafter, those optical composite modules, that is, the optical composite modules 58 (#1) to 58 (#8), are collectively referred to as the transmitting optical composite module 58 except for the case where a transmitting optical composite module with a specific wavelength has to be distinguished from the others.

The structure of the transmitting optical composite module 58 is similar to that described in the fourth, fifth, or sixth embodiment. The transmitting optical composite module 58 is divided into two types: transmitting optical composite modules 58 (#1) to 58 (#4) that outputs wavelengths λ1 to λ4 (a first wavelength band), and transmitting optical composite modules 58 (#5) to 58 (#8) that outputs wavelengths λ5 to λ8 (a second wavelength band).

In the first wavelength band, the transmitting optical composite modules 58 (#1) to 58 (#4) are placed in series in descending order from the optical composite module 58 (#4) to 58(#3) to 58(#2) to 58 (#1). When two transmitting optical composite modules are connected, an output optical fiber of one transmitting optical composite module is connected to an input optical fiber of the other transmitting optical composite module. The transmitting optical composite module 58 (#1) finally outputs the wavelength-multiplexed optical signal with wavelengths λ1 to λ4 and inputs the wavelength-multiplexed signal into the optical multiplexer 59.

Similarly, in the second wavelength band, the transmitting optical composite modules 58(#5) to 58 (#8) are placed in series in descending order from the optical composite module 58 (#8) to 58 (#7) to 58 (#6) to 58 (#5). The transmitting optical composite module 58 (#5) finally outputs the wavelength-multiplexed optical signal with wavelengths λ5 to λ8 and inputs the wavelength-multiplexed signal into the optical multiplexer 59.

The optical multiplexer 59 multiplexes the optical signal with wavelengths λ1 to λ4 output from the transmitting optical composite module 58 (#1) and the optical signal with wavelengths λ5 to λ8 output from the transmitting optical composite module 58 (#5), and inputs the resultant multiplexed signal into the optical fiber 40.

The optical wavelength demultiplexer 60 includes an optical demultiplexer 69 and eight receiving optical composite modules 68. The receiving optical composite module 68 that receives an optical signal with wavelengths λi is denoted as a receiving optical composite module 68 (#i). The optical demultiplexer 69 demultiplexes the optical signal with wavelengths λ1 to λ8 inputted from the optical fiber 40 into the optical signal in the first wavelength band and the optical signal in the second wavelength band. The optical demultiplexer 69 then inputs the optical signal in the first wavelength band into the receiving optical composite module 68 (#4), and inputs the optical signal in the second wavelength band into the receiving optical composite module 68 (#8).

The structure of the receiving optical composite module 68 is similar to that of the optical composite module described in the above-described first to third embodiments, or the sixth embodiment. The receiving optical composite module 68 (#i) receives an optical signal with wavelengths λi, and converts the received optical signal into an electric signal. In order to demultiplex the optical signal in the first wavelength band, the receiving optical composite modules 68(#1) to 68 (#4) are connected in series in descending order from the optical composite module 68 (#4) to 68(#3) to 68(#2) to 68 (#1). In order to demultiplex the optical signal in the second wavelength band, the receiving optical composite modules 68 (#5) to 68 (#8) are connected in series in descending order from the optical composite module 68 (#8) to 68(#7) to 68(#6) to 68 (#5).

Next, operations of multiplexing and demultiplexing in the above-described system are described.

First, the optical signal with wavelength λ4 output from the transmitting optical composite module 58 (#4) is reflected by a BPF (not shown) within the transmitting optical composite module 58 (#3). The reflected optical signal is then multiplexed with the optical signal with wavelength λ3 output from the transmitting optical composite module 58 (#3), and inputted into the transmitting optical composite module 58 (#2). The optical signal inputted into the transmitting optical composite module 58 (#2) is multiplexed with the optical signal with wavelengths λ2 and λ1 in the transmitting optical composite modules 58 (#2) and 58 (#1), respectively, following the same process as described above. As a result, the multiplexed optical signal with wavelengths λ1 to λ4 is inputted into the optical multiplexer 59. Similarly, the optical signals in the second wavelength band are multiplexed in the transmitting optical composite modules 58 (#8) to 58 (#5), and the resultant multiplexed signal is inputted into the optical multiplexer 59.

The optical multiplexer 59 multiplexes the inputted optical signals in the first wavelength band and the second wavelength band, and inputs the resultant multiplexed signal into the optical fiber 40. The optical signal with wavelengths λ1 to λ8 transmitting over the optical fiber 40 enters an input end of the optical demultiplexer 69, and is demultiplexed into the optical signal in the first wavelength band and the optical signal in the second wavelength band. The optical signal in the first wavelength band demultiplexed in the optical demultiplexer 69 is inputted into the receiving optical composite module 68 (#4) provided with a BPF that passes the optical signal with wavelengths λ4, thereby extracting only the optical signal with wavelength λ4 and converting the extracted signal into the electric signal. The optical signal with wavelengths λ1 to λ3 is reflected by the BPF, and inputted into the receiving optical composite module 68 (#3) in the next stage. In the receiving optical composite module 68 (#3), only the optical signal with wavelength λ3 is extracted, and the optical signal with wavelengths λ1 and λ2 is reflected and inputted into the receiving optical composite module 68(#2) in the next stage. The optical signals with wavelengths λ1 and λ2 are each extracted in the corresponding receiving optical composite modules 68 (#2) and 68 (#1) by the process similar to those described above. The optical signal in the second wavelength band is inputted into the receiving optical composite module 68 (#8), and demultiplexed into the light with wavelength λ8, λ7, λ6, λ5 in the corresponding receiving optical composite modules 68 (#8) to 68 (#5) as in the same of the optical signal in the first wavelength band.

Next, light loss of the above-described optical wavelength multiplexer 50 and the optical wavelength demultiplexer 60 is described. Hereinafter, multiplex loss of the optical multiplexer 59 or demultiplex loss of the optical demultiplexer 69 is denoted as Δ1, and insertion loss of the transmitting optical composite module 58 and the receiving optical composite module 68 is denoted as Δ2. Also, the number of demultiplexing is denoted as n (in the present embodiment, n=8).

In the case of the above-described optical wavelength multiplexer 50 and the optical wavelength demultiplexer 60, excess loss of light output from the transmitting optical composite module in the last stage (in FIG. 13, the transmitting optical composite module 58 (#4) or 58 (#8)) and excess loss of light inputted into the optical wavelength demultiplexer, which is caused in the receiving optical composite module in the last stage, (in FIG. 13, the receiving optical composite module 68 (#1) or 68 (#5)) are represented as Δ1+(n/2−1)×Δ2 (if n is an odd-number, n=n+1 in the above-described calculation).

Here, light loss of an optical wavelength multiplexer provided with n stages of transmitting optical composite modules connected to each other in series but not provided with an optical multiplexer and an optical wavelength demultiplexer provided with n stages of receiving optical composite modules connected to each other in series but not provided with an optical demultiplexer is considered. In this case, excess loss of light output from the transmitting optical composite module in the last stage and excess loss of light inputted into the optical wavelength demultiplexer, which is caused in the receiving optical composite module in the last stage, is represented as (n−1)×Δ2.

For example, the case where Δ1=Δ2=0.5 dB and n=8 is considered. In this case, excess loss of the optical wavelength multiplexer provided with an optical multiplexer and the optical wavelength demultiplexer provided with an optical demultiplexer is 2 dB. On the other hand, excess loss of the optical wavelength multiplexer with 8 stages of transmitting optical composite modules connected to each other in series and the optical wavelength demultiplexer provided with 8 stages of receiving optical composite modules connected to each other in series is 3.5 dB.

As described above, in the seventh embodiment, the optical wavelength multiplexer 50 multiplexes wavelengths to be multiplexed in the optical multiplexer by dividing the wavelengths into two wavelength band, and the optical wavelength demultiplexer 60 demultiplexes a wavelength to be demultiplexed in the optical demultiplexer for dividing the wavelengths into two wavelength bands. As a result, it is possible to reduce light loss.

Furthermore, the use of the optical composite module including a light-emitting element or a light-receiving element allows a low-loss and small-sized optical wavelength multiplexer and an optical wavelength demultiplexer to be provided.

Also, a larger number of wavelength bands can reduce excess loss still lower. In this case, the transmitting optical composite modules may be connected to each other on a wavelength band basis in the optical wavelength multiplexer, and the optical multiplexer provided with as many input ports as the number of the wavelength bands may multiplex the light in each wavelength band. Also, the receiving optical composite modules may be connected to each other on a wavelength band basis in the optical wavelength demultiplexer, and the optical demultiplexer provided with as many output ports as the number of the wavelength bands may demultiplex the light in each wavelength band.

Note that, in the seventh embodiment, unidirectional optical communication has been described, but it is also possible to use the above-described optical composite module in bi-directional optical communication. In this case, the transmitting optical composite modules 58 (#5) to 58 (#8) in the optical wavelength multiplexer 50 may be replaced with the receiving optical composite modules 68 (#5) to 68 (#8), the optical multiplexer 59 with a WDM coupler, etc., for multiplexing/demultiplexing the optical signals in the first wavelength band and the second wavelength band, the receiving optical composite modules 68 (#5) to 68 (#8) in the optical wavelength demultiplexer 60 with the transmitting optical composite modules 58 (#5) to (#8), and the optical demultiplexer 69 with a WDM coupler, etc., for multiplexing/demultipiexing the optical signals in the first wavelength band and the second wavelength band. As a result, a wavelength multiplexer/demultiplexer that realizes bi-directional communication is provided. Also in this case, optical signals to be transmitted are divided into a plurality of wavelength bands in order to minimize light loss. The optical multiplexer multiplexes the optical signals on a wavelength band basis, the optical signals output from a plurality of transmitting optical composite modules connected to each other in series. The optical demultiplexer demultiplexes the optical signals to be received by a plurality of receiving optical composite modules connected to each other in series on a wavelength band basis.

(Eighth Embodiment)

In the system according to the above-described seventh embodiment, if any transmitting optical composite module 58 (for example, the transmitting optical composite module 58 (#6)) breaks down, the broken down transmitting optical composite module 58 has to be disconnected for replacing. As a result, transmission of the light output from the transmitting optical composite module 58 connected in the previous stage (for example, the transmitting optical composite modules 58 (#7) and 58 (#8)) is interrupted, whereby transmission of the optical signal with the wavelength is suspended. Similarly, if any receiving optical composite module 68 (for example, the receiving optical composite module 68 (#7)) breaks down and is replaced, transmission of the light signal to be received by the receiving optical composite module 68 connected in the next stage (for example, the receiving optical composite modules 68 (#6) and 68 (#5)) is interrupted.

As described above, in the case where an optical system having a multistage structure with a plurality of optical composite modules is constructed by using the optical composite module of the present invention, replacement of any broken down optical composite module can affect the entire transmission. Therefore, an optical composite module that can solve the above-described problem is proposed in an eighth embodiment.

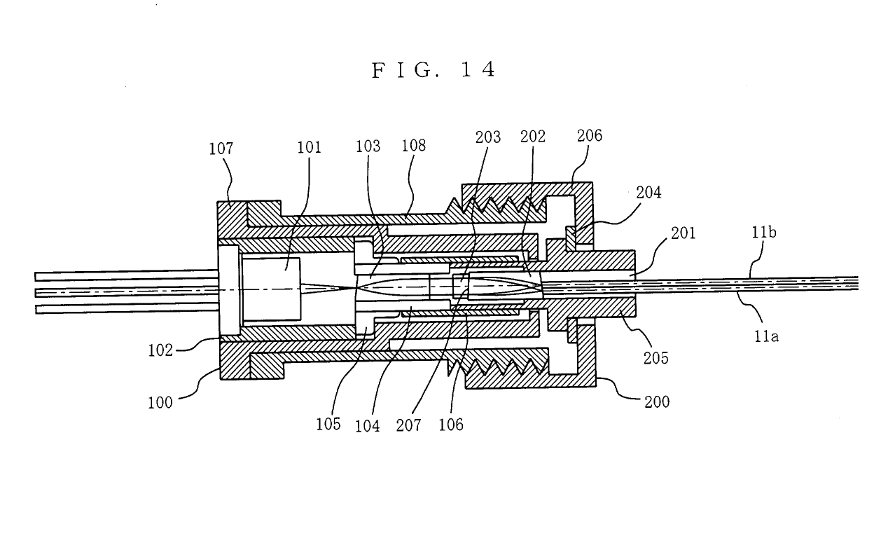

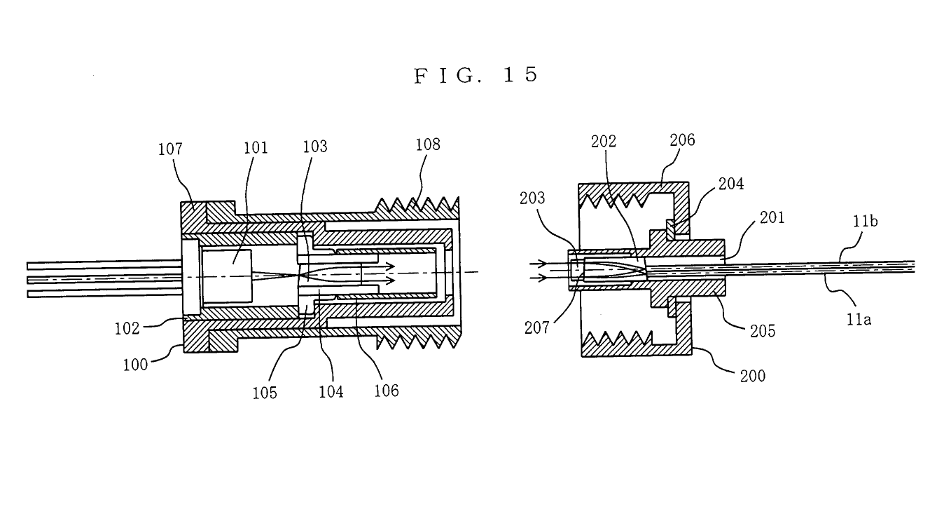

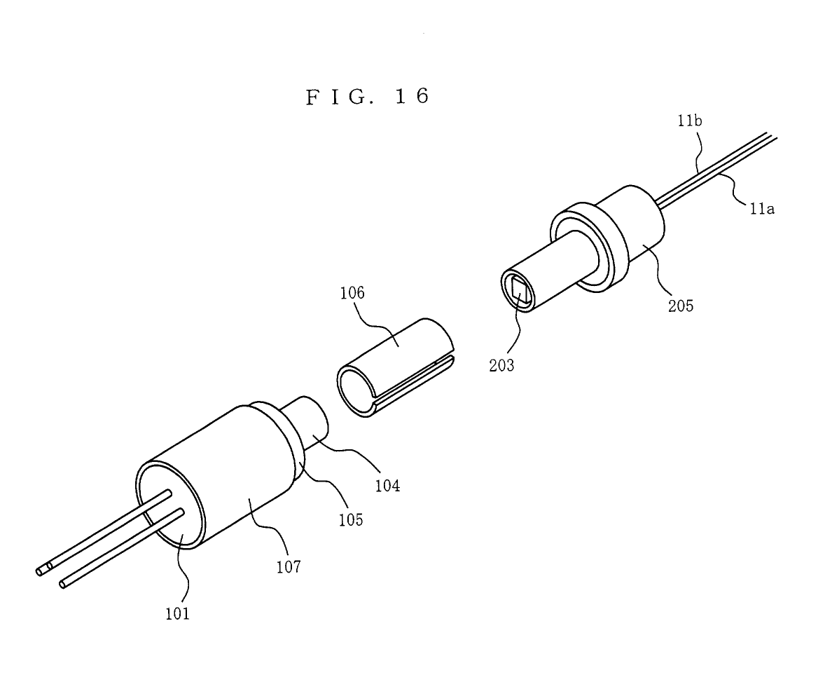

FIG. 14 is a section view showing the structure of the optical composite module according to the eighth embodiment of the present invention. FIG. 15 is a section view showing the structure of the optical composite module according to the eighth embodiment, which is dismantled into two parts. FIG. 16 is an exploded perspective view showing a position of a split sleeve within the optical composite module according to the eighth embodiment of the present invention. In FIGS. 14, 15, and 16, the optical composite module includes a semiconductor laser collimator unit 100 and an optical fiber reflective coupling unit 200.

The semiconductor laser collimator unit 100 includes a light-emitting element 101, a semiconductor laser package 102, a convergent rod lens 103, a lens holder 104, an alignment sleeve 105, a split sleeve 106, a holder 107, and a male screw 108.

The light-emitting element 101 is a semiconductor laser including a converging lens within a CAN package. The light-emitting element 101 is placed so that light emitted therefrom is focused on a single point on the center of the end surface of the convergent rod lens 103. The light-emitting element 101 press-fitted into the semiconductor laser package 102 is bonded to the holder 107.

The convergent rod lens 103 converts the emitted light from the light-emitting element 101 into collimated light. An end of the convergent rod lens 103, which faces the light-emitting element, is angled for preventing the light emitted from the light-emitting element 101 from being reflected and returning thereto. If an antireflective film, etc., is used in order to eliminate back reflection, the convergent rod lens 103 does not have to be angled. The convergent rod lens 103 is mounted in the lens holder 104.

The lens holder 104 is fitted into the alignment sleeve 105. The outer diameter of the lens holder 104 and the inner diameter of the alignment sleeve 105 are substantially the same. The alignment sleeve 105 is a positioning component for holding the semiconductor laser package 102 and the lens holder 104 so that the emitted light from the light-emitting element 101 is converted into collimated light by the convergent rod lens 103, and the collimated light is output in parallel with the optical axis of the convergent rod lens 103. Thus, the light-emitting element 101 and the convergent rod lens 103 are secured at the optimum position with regard to both the optical axis and the plane normal thereto by the semiconductor laser package 102 and the alignment sleeve 105.

The split sleeve 106 is a cylinder having a longitudinal slit on the side thereof, and the inner diameter thereof is equal to the outer diameter of the lens holder 104. The holder 107 is a component for holding the semiconductor laser package 102, the alignment sleeve 105, the lens holder 104, and the split sleeve 106. The holder 107 is mounted in the male screw 108.

The optical fiber reflective coupling unit 200 includes a double-core glass tube 201, a convergent rod lens 202, a BPF 203, an elastic body 204, an optical fiber package 205, and a female screw 206. The optical fiber reflective coupling unit 200 multiplexes the light emitted from the light-emitting element 101 and the light output from the input optical fiber 11a, and outputs the multiplexed light into the output optical fiber 11b.

The double-core glass tube 201 is a glass tube for mounting the input optical fiber 11a and the output optical fiber 11b therein. The center of the double-core glass tube 201 coincides with the optical axis of the convergent rod lens 202. The double-core glass tube 201 has two bore holes; one is piercing through the center for mounting the output optical fiber 11b and the other is appropriately apart from the above-described bore hole for mounting the input optical fiber 11a. The double-core glass tube 201 and the convergent rod lens 202 are equal in outer diameter.

An interface surface between the double-core glass tube 201 and the convergent rod lens 202 is polished and angled for eliminating back reflection. If the reflected light has negligible effects, the interface surface may not be polished and angled.

The convergent rod lens 202 focuses the collimated light output from the convergent rod lens 103 through the BPF 203 on the input end of the output optical fiber 11b, and also focuses the light output from the input optical fiber 11a and reflected by the BPF 203 on the input end of the output optical fiber 11b. The optical axis of the convergent rod lens 202 coincides with the center of the output optical fiber 11b.

The BPF 203 passes the light within a wavelength band emitted from the light-emitting element 101 but reflects the light with a wavelength lying outside of this band.

The evaporated interface surface between the convergent rod lens 202 and the BPF 203 is angled so as to focus the light reflected by the BPF 203 among the light output from the input optical fiber 11a on the input end of the output optical fiber 11b. Thus, the angle of the angled end can be calculated based on the distance from the optical axis of the convergent rod lens 202 to the center of the output optical fiber 11b.

The optical fiber package 205 is a package for mounting the convergent rod lens 202 and the double-core glass tube 201 therein. The convergent rod lens 202 and the double-core glass tube 201 are each inserted into the optical fiber package 205 from each end thereof so as to have a surface contact, thereby allowing the center of the output optical fiber 1b to coincide with the optical axis of the convergent rod lens 202. Thus, a coupling position between the input and output optical fibers and the convergent rod lens 202 can be adjusted easily.

The female screw 206 is a component for screwing the male screw 108 thereinto, and secured to the optical fiber package 205. The elastic body 204 is an elastic solid such as rubber used for preventing the male screw 108 and the female screw 206 from being excessively tightened or from being loosened.

Hereinafter, an operation of the optical composite module is described.

In the following descriptions, light with wavelengths λ2 to λ8 is assumed to be output from the input optical fiber 11a lying on the optical axis of the convergent rod lens 202 and light with wavelength λ1 is assumed to be emitted from the light-emitting element 101. Also, the BPF 203 is assumed to pass the light with wavelength λ1 but reflect the light with wavelength lying outside of this band.

The light with wavelengths λ2 to λ8 output from the input optical fiber 11a is converted into collimated light by the convergent rod lens 202, and enters the BPF 203. The BPF 203 reflects the light with wavelengths λ2 to λ8. The reflected light with wavelengths λ2 to λ8 is focused by the convergent rod lens 202 on the input end of the output optical fiber 11b located at a point different from the output end of the input optical fiber 11a, due to the angled interface surface between the BPF 203 and the convergent rod lens 202, and coupled into the output optical fiber 11b.

On the other hand, the light with wavelength λ1 emitted from the light-emitting element 101 is focused on the optical axis lying on the end of the convergent rod lens 103 by the action of the built-in convergent rod lens. The focused light is then converted into collimated light traveling in parallel with the optical axis by the convergent rod lens 103, and output therefrom. The collimated light output from the convergent rod lens 103 passes through the air, and enters the BPF 203 perpendicularly. The collimated light then enters the convergent rod lens 202 after passing through the BPF 203.

The collimated light enters the convergent rod lens 202 at a point where the light with wavelengths λ2 to λ8 output from the input optical fiber 22a is reflected. Thus, the collimated light entering the convergent rod lens 202 is focused thereby on the input end of the output optical fiber 11b, and coupled into the output optical fiber 11b. As a result, the light with wavelength λ1 and the light with wavelengths λ2 to λ8 are multiplexed.

Under the above-described operating environment, if the output level of the emitted light from the light-emitting element 101 becomes lowered due to deterioration of the semiconductor laser, a user has to replace the semiconductor laser collimator unit 100. In order to replace the semiconductor laser collimator unit 100, the user isolates the semiconductor laser collimator unit 100 by loosening the male screw 108 and the female screw 206.

Even when the semiconductor laser collimator unit 100 is isolated, the optical fiber reflective coupling unit 200 functions effectively, whereby the light output from the input optical fiber 11a is reflected by the BPF 203 and coupled into the output optical fiber 11b. Thus, transmission of the light with wavelengths λ2 to λ8 is performed orderly without being interrupted.

The user can resume transmission of the light with wavelength λ1 by replacing the isolated semiconductor laser collimator unit 100 with a new one. The light output from the convergent rod lens 103 is collimated light traveling in parallel with the optical axes of the convergent rod lenses 103 and 202. Thus, it is possible to couple the light output from the convergent rod lens 103 into the convergent rod lens 202 with ease, whereby the user does not have to perform high precision positioning when replacing a component.

Also, the split sleeve 106 enables easy insertion of the convergent rod lens 202 into the semiconductor laser collimator unit 100, whereby the user can replace a component with ease.

As such, according to the eighth embodiment, it is possible to provide the optical composite module that allows a component of the semiconductor laser to be replaced easily.

Note that, in the above-described eighth embodiment, the light with wavelengths λ2 to λ8 is assumed to be output from the input optical fiber 11a, but the light may be inputted from the output optical fiber 11b when a bi-directional transmission is performed.

Note that, in the above-described eight embodiment, the male screw 108 and the female screw 206 are assumed to be used in order to connect the semiconductor laser collimator unit 100 with the optical fiber reflective coupling unit 200, but that is not restricted thereto. Any component enabling mating and unmating of those two units may be used. For example, those two units may be connected to each other with a bolt and nut.

(Manufacturing Method)

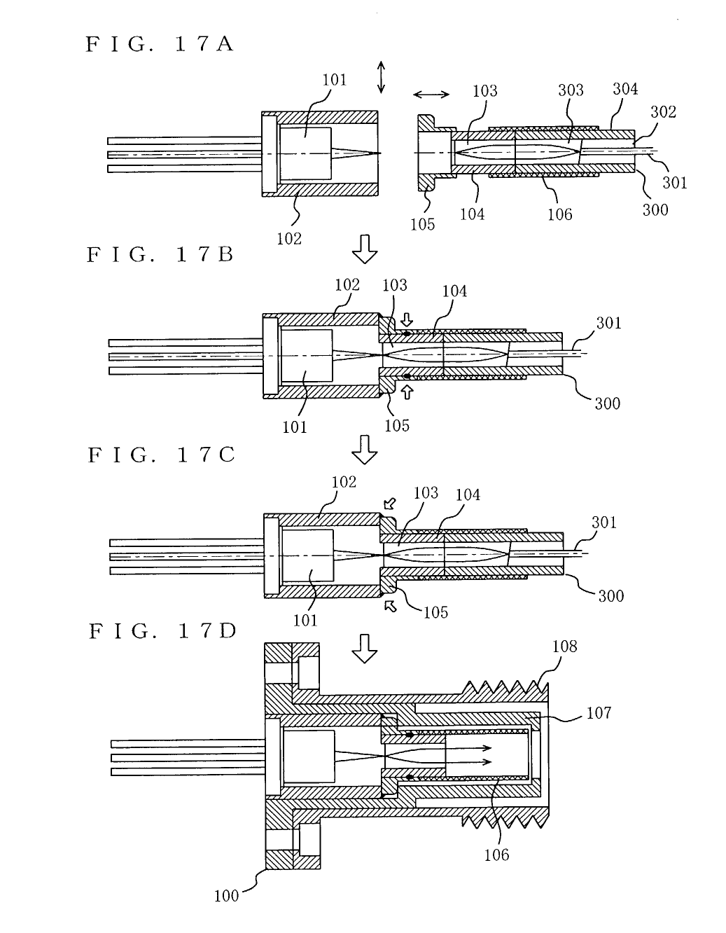

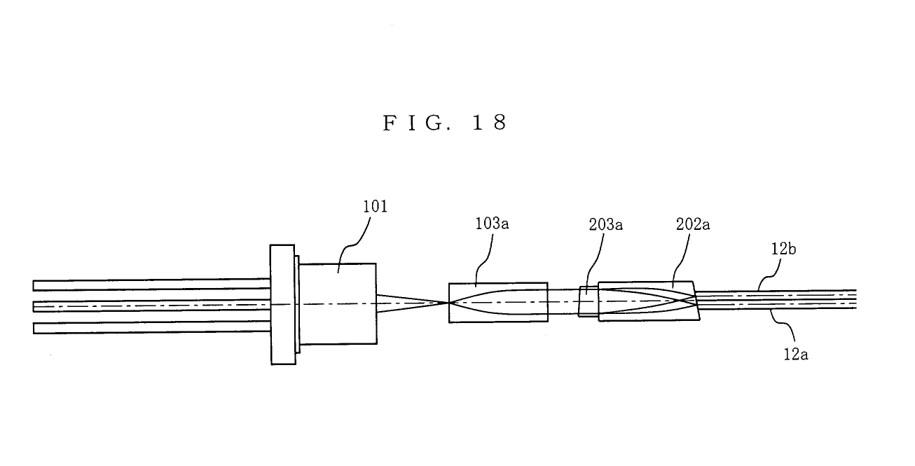

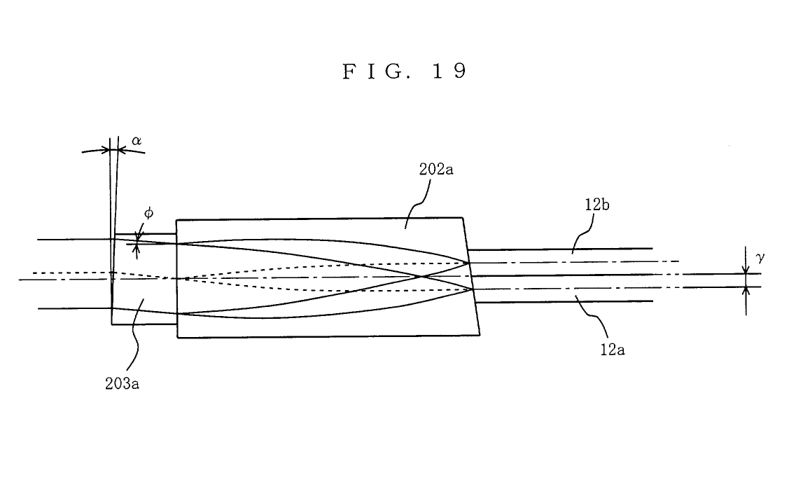

FIGS. 17A, 17B, 17C, and 17D are illustrations showing a manufacturing method of the semiconductor laser collimator 100 according to the eighth embodiment of the present invention. Hereinafter, with reference to FIGS. 17A, 17B, 17C, and 17D, the manufacturing method of the semiconductor laser collimator 100 is described.

A manufacturer uses a single optical fiber collimator 300 in order to manufacture the semiconductor laser collimator 100. The single optical fiber collimator 300 includes an optical fiber 301, a single-core glass tube 302, a convergent rod lens 303, and a holder 304. The convergent rod lens 303 and the single-core glass tube 302 are mounted in the holder 304. The single-core glass tube 302 has a bore hole whose axis coincides with the optical axis of the convergent rod lens 303, and the optical fiber 301 is inserted into the bore hole. An interface surface between the single-core glass tube 302 and the convergent rod lens 303 is angled in order to eliminate back reflection. The interface surface, however, may not be angled.

The convergent rod lens 303 has a refractive index distribution that focuses collimated light on an end of the optical fiber 301 if the collimated light enters from the end that does not face the single-core glass tube.

The holder 304 and the lens holder 104 are equal in outer diameter, and fitted into the split sleeve 106.

The manufacturer first inserts the single optical fiber collimator 300 into the split sleeve 106 from one end thereof, and inserts the lens holder 104 mounting the convergent rod lens 103 thereinto from the other end for bringing the end of the convergent rod lens 303 into close contact with the end of the convergent rod lens 103.

Next, the manufacturer inserts the lens holder 104 into the alignment sleeve 105.

Next, the manufacturer performs a rough adjustment of the position of the convergent rod lens 103 so as to couple the light emitted from the light-emitting element 101 mounted in the semiconductor laser package 102 into the optical fiber 301 (see FIG. 17A) by bringing the alignment sleeve 105 into contact with the end of the semiconductor laser package 102, and moving the alignment sleeve 105 in the direction of the normal to the optical axis and moving the lens holder 104 inserted into the alignment sleeve 105 in the direction of the optical axis. The manufacturer can determine whether the light is coupled into the optimum position or not by detecting an output from the optical fiber.

Next, the manufacturer keeps the end of the alignment sleeve 105 brought into contact with the semiconductor laser package 102, and moves the lens holder 104 inserted into the alignment sleeve 105 in the direction of the optical axis, thereby determining the position of the convergent rod lens 103 so that an output from the optical fiber 301 becomes maximized. After the above-described determination, the manufacturer irradiates the YAG laser from the side of the alignment sleeve 105, and welds the alignment sleeve 105 and the lens holder 104 for securing the convergent rod lens 103 at the position determined as described above (see FIG. 17B).

Next, the manufacturer keeps the end of the alignment sleeve 105 brought into contact with the semiconductor laser package 102, and moves the adjustment holder 105 in the direction of the normal to the optical axis, thereby determining the position of the convergent rod lens 103 so that an output from the optical fiber 301 becomes maximized. After the above-described determination, the manufacturer irradiates the alignment sleeve 105 and the semiconductor laser package 102 with the YAG laser for welding. Thus, the positions of the convergent rod lens 103 and the light-emitting element 101 are finally determined (see FIG. 17C).

Finally, the manufacturer pulls out the single optical fiber collimator 300 from the split sleeve 106, and attaches the holder 107 and the male screw 108 for finishing the semiconductor laser collimator unit 100 (see FIG. 17D).

As described above, according to the above-described manufacturing method, the semiconductor laser collimator unit 100 can be manufactured without utilizing a double-core glass tube and a optical collimator used in the optical fiber reflective coupling unit 200, thereby allowing the optical composite module to be manufactured easily. Thus, the optical composite module according to the eighth embodiment has an advantage in manufacturability.

The optical composite module also functions as an optical demultiplexer if the above-described light-emitting element 101 according to the eighth embodiment is replaced with a light-receiving element. In this case, the BPF 203 may be at least provided with a property of passing only the light with a wavelength to be demultiplexed and reflecting the light of other wavelengths. The manufacturing method of the above-described demultiplexer is basically similar to that shown in FIGS. 17A, 17B, 17C, and 17D, but differs therefrom only in that the alignment sleeve 105 and the lens holder 104 are welded for securing the convergent rod lens 103 at the position where an output from the light-receiving element becomes maximized in response to the light output from the optical fiber 301.

(Ninth Embodiment)

FIG. 18 is an illustration showing the structure of an optical system of an optical composite module according to a ninth embodiment of the present invention. FIG. 19 is an enlarged view showing a reflection optical path and a transmission optical path of the optical system on the optical fiber side of the optical composite module according to the ninth embodiment.

In the ninth embodiment, the construction for holding the components of the optical system is similar to that of the eighth embodiment. Thus, only the structure of the optical system is described with reference to FIGS. 14 to 16. In the FIGS. 18 and 19, the components that function in similar manners are denoted by like numerals. Also, the components that function in similar manners to their counterparts shown in the eighth embodiment are denoted by like numerals.

In FIG. 18, the optical composite module includes the light-emitting element 101, a convergent rod lens 103a, a BPF 203a, and a convergent rod lens 202a.

The end of the convergent rod lens 202a, which faces the optical fiber, is angled for eliminating back reflection. If the reflected light has negligible effects, the above-described end may not be angled. The interface surface between the convergent rod lens 202a and the BPF 203a are normal to the optical axis.

The other end of the BPF 203a is angled at α degrees. The angle α will be described below. The BPF 203a passes only the light with wavelength λ1 but reflects the light with other wavelengths.

An input optical fiber 12a and an output optical fiber 12b are placed so as to be symmetric with respect to the optical axis of the convergent rod lens 202a.

The light output from the input optical fiber 12a is converted into collimated light by the convergent rod lens 202a, and enters the BPF 203a. The BPF 203a passes only the light with wavelength λ1 but reflects the light with wavelengths λ2 to λ8.

The light with wavelengths λ2 to λ8 reflected by the BPF 203a is focused by the convergent rod lens 202a, and coupled into the output optical fiber 12b.

On the other hand, the light with wavelength λ1 emitted from the light-emitting element 101 is focused on the optical axis lying on the end of the convergent rod lens 103a by the action of the built-in convergent rod lens. The focused light is then converted into collimated light traveling in parallel with the optical axis by the convergent rod lens 203a, and output therefrom. The collimated light output from the convergent rod lens 103a passes through the air, and enters the BPF 203a. The collimated light is refracted by the angled end of the BPF 203a, and enters the end of the convergent rod lens 202a at an angle of φ degrees. The angle φ will be described below.

Next, the angle α and the angle φ are described.

If the distance from the optical axis of the convergent rod lens 202a to the axis of the output optical fiber 12a is assumed to be r, an axial refractive index of the convergent rod lens 202a is assumed to be n, a constant of the refractive index distribution of the convergent rod lens 202 is assumed to be g, and an refractive index of a glass block (not shown) for mounting the BPF 203a thereon is assumed to be n1, the angle φ, at which angle the light is output from the end of the convergent rod lens 202a, is represented as

φ=ngr/n1 (radian) (1).

Here, substituting the value of g into Equation (0.294), the value of n into Equation (1.59), the value of r into Equation (0.0625 (mm)),and the value of n1 into Equation (1.5) yields φ=1.11. That is, if collimated light is inputted into the end of the convergent rod lens 202a at an angle of 1.11 degrees, the inputted collimated light is focused on a single point 62.5 μm from the optical axis on the other end of the convergent rod lens 202a.

The angle α of the end of the glass block has to satisfy the following equation (2);

n1·sin (α−φ)=n0·sin α (2).

Here, n0 is the refractive index of the air (n0=1). If the angle α satisfies the above-described equation, the collimated light inputting from the angled end of the BPF 203a is inputted into the end of the convergent rod lens 202a at an angle φ, and focused on the end of the optical fiber 12a.

The angle α is determined as approximately 2.22 degrees by using the above-described equations (1) and (2).

As described above, according to the ninth embodiment, the interface surface between the BPF 203a and the convergent rod lens 202a is normal to the optical axis, thereby realizing easy construction.

Also, the collimated light travels in parallel with the optical axis from the convergent rod lens 103a to the BPF 203a. Thus, it is possible to input the light into an appropriate point of the angled end of the convergent rod lens 202a. As a result, the user does not have to perform high precision positioning when replacing the light-emitting element 101.

The optical composite module also functions as an optical demultiplexer if the above-described light-emitting element 101 according to the eighth embodiment is replaced with a light-receiving element. In this case, the BPF 203a may be at least provided with a property of passing only the light with a wavelength desired to be demultiplexed and reflecting the light of other wavelengths.

In the ninth embodiment, the light travels from the light-emitting element 101 to the convergent rod lens 103a in similar manners as described in the eighth embodiment. Thus, the manufacturing method of the optical composite module according to the ninth embodiment is similar to that described in the eighth embodiment with respect to both the optical multiplexer and the optical demultiplexer. Specifically, in order to manufacture the optical demultiplexer, the manufacturer removably inserts the single optical fiber collimator into the split sleeve from the one end thereof, and inserts the lens holder 104 mounting the convergent rod lens 103 therein from the other end of the split sleeve 106, and inserts the lens holder 104 into the alignment sleeve 105. Then, the manufacturer outputs the light from the optical fiber 301 for determining a position of the convergent rod lens 103 so that an output from the light-receiving element becomes maximized. The manufacturer then welds the alignment sleeve 105 and the lens holder 104, and welds the alignment sleeve 105 and the component holding the light-receiving element. Finally, the manufacturer pulls out the single optical fiber collimator from the split sleeve 106 for finishing the optical composite module that functions as the optical demultiplexer.

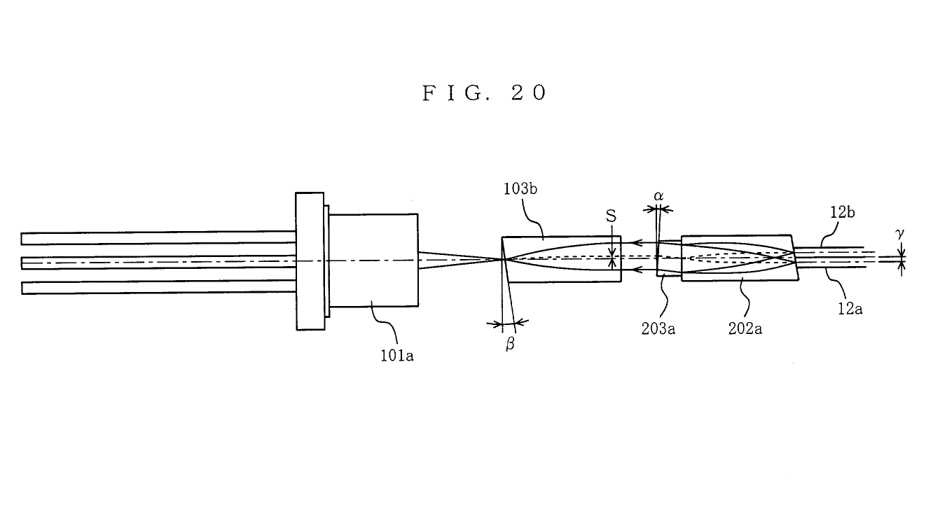

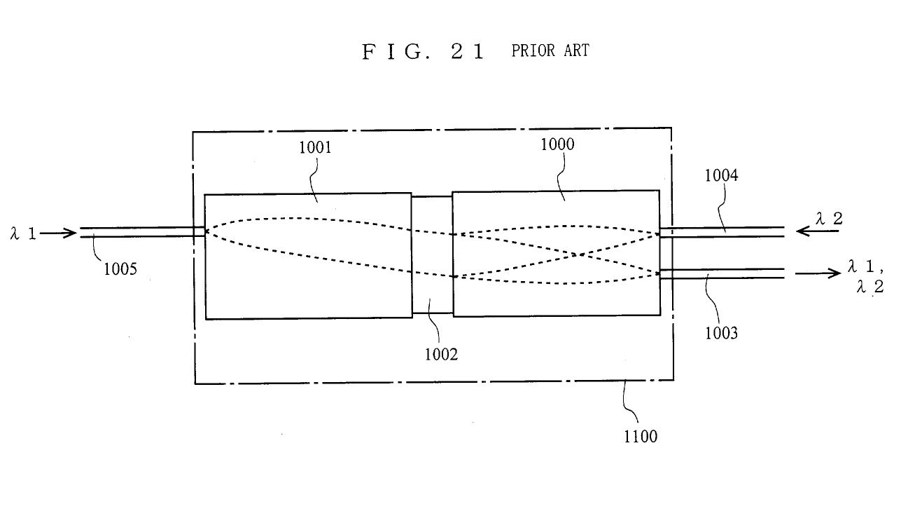

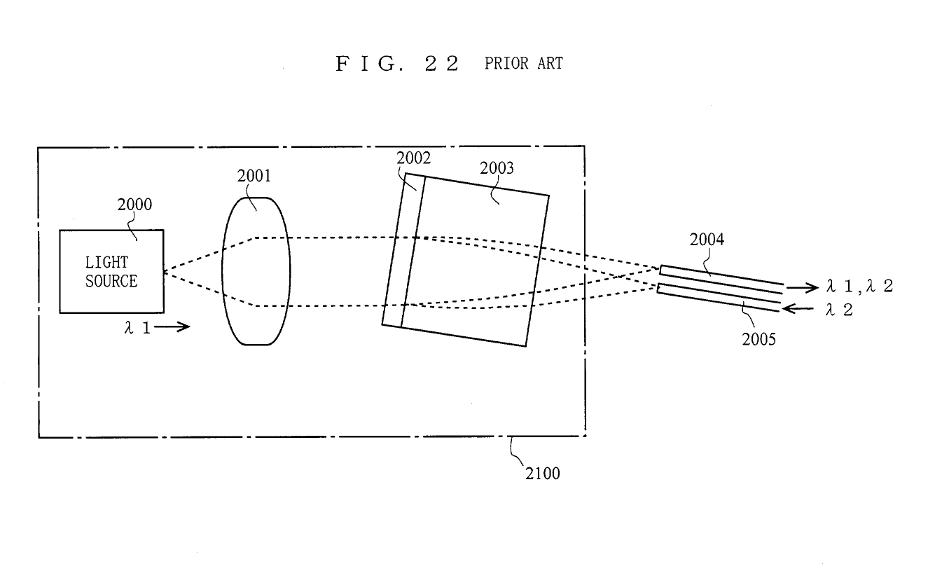

FIG. 20 is an illustration showing the structure of an optical composite module according to the ninth embodiment. The optical composite module includes a light-receiving element instead of a light-emitting element. The optical composite module shown in FIG. 20 is provided with a convergent rod lens 103b whose output end of is angled. The angled end allows the focused light to be output as light whose center coincides with the optical axis instead of being refracted and output in a slanting direction. As a result, the light is coupled into the light-receiving element 101a with higher precision.

In the case where the center line of the collimated light output from the BPF 203a is misaligned from the optical axis by S (mm), an angle β of the output end of the convergent rod lens 103b is represented as

β≈ngS (3).

As described above, the optical composite module according to the present invention includes a light-emitting element or a light-receiving element each having an optical multiplex/demultiplex function, thereby realizing reduction of size and insertion loss. Also, the use of a positioning component for coinciding the center line of two optical fibers with an optical axis of a convergent rod lens enables easy positioning of the input and output optical fibers. Furthermore, it is possible to provide the optical composite module having an advantage in mountability due to the configuration of the input and output optical fibers connected to the same side thereof. Still further, even when the light-emitting element emitting light with a wavelength or the light-receiving element receiving light with a wavelength is replaced, the optical composite module according to the present invention does not interrupt transmission of light with other wavelengths.

While the invention has been described in detail, the foregoing description is in all aspects illustrative and not restrictive. It is understood that numerous other modifications and variations can be devised without departing from the scope of the invention.

What is claimed is:

1. An optical composite module that demultiplexes light having a plurality of wavelengths output from an input optical fiber for converting light of a predetermined range of wavelengths into an electric signal and outputting light outside of the predetermined wavelengths to an output optical fiber, comprising:
an optical filter that passes the light falling within a predetermined range of wavelengths to be converted into the electric signal, and reflects the light outside of the predetermined wavelengths;
a first convergent rod lens for converting the light output from the input optical fiber into collimated light for inputting into the optical filter, and focusing the collimated light reflected by the optical filter on an end of the output optical fiber, which is placed between the input and output optical fibers and the optical filter;
a light-converging section for focusing the collimated light passing through the optical filter on a single point;
a light-receiving element for receiving the light focused by the light-converging section and converting the received light into the electric signal; and
a positioning component for coinciding an optical axis of the first convergent rod lens with a center line between the input optical fiber and the output optical fiber.

2. The optical composite module according to claim 1, wherein the positioning component includes:
a cylindrical lens holder for holding the first convergent rod lens, an axis of the lens holder coinciding with the axis of the first convergent rod lens; and
an optical fiber holder whose outer diameter is equal to that of the lens holder, the optical fiber holder having two guide holes for holding the input optical fiber and output optical fiber such that the two optical fibers are placed equidistant from an axis thereof.

3. The optical composite module according to claim 1, wherein the positioning component is a package having two guide holes therein for holding the input optical fiber and the output optical fiber such that the two optical fibers are placed equidistant from the optical axis of the first convergent rod lens.

4. The optical composite module according to claim 1, wherein the light-converging section placed between the optical filter and the light-receiving element is a ball lens for focusing the collimated light output from the optical filter on the light-receiving element.

5. The optical composite module according to claim 1, wherein the light-converging section includes:
a second convergent rod lens placed between the optical filter and the light-receiving element for focusing the collimated light passing through the optical filter; and
a ball lens placed between the second convergent rod lens and the light-receiving element for refocusing the light having been diverged after being focused by the second convergent rod lens on the light-receiving element.

6. The optical composite module according to claim 1, wherein the light-converging section placed between the optical filter and the light-receiving element is a second convergent rod lens for focusing the collimated light passing through the optical filter on the light-receiving element.

7. The optical composite module according to claim 1, further comprising a light-receiving element positioning component for placing the light-receiving element at a focal point determined by an action of the light-converging section.

8. The optical composite module according to claim 7, wherein the light-receiving element positioning component includes:
a cylindrical holder whose axis coincides with the optical axis of the first convergent rod lens for holding the first convergent rod lens; and
a light-receiving element holder for holding the light-receiving element, whose outer diameter is equal to that of the cylindrical holder, wherein
the light-receiving element holder locks the light-receiving element in a position corresponding to the focal point when being rotated so that a relative angle formed with the cylindrical holder is adjusted to the predetermined angle.

9. An optical composite module that outputs light modulated by an inputted electric signal and multiplexes the modulated light and light having a plurality of wavelengths output from an input optical fiber for output to an output optical fiber, comprising:
a light-emitting element for emitting the light modulated by the inputted electric signal;
a collimator for converting the light emitted from the light-emitting element into collimated light;
an optical filter that passes light of a predetermined range of wavelengths inputted from the collimator and reflects light outside of the predetermined wavelengths among light inputted thereinto, which is placed between the collimator and the input and output optical fibers;
a first convergent rod lens placed between the optical filter and the input and output optical fibers for converting the light output from the input optical fiber into collimated light, inputting the converted light into the optical fiber, and focusing the collimated light reflected by the optical filter and the collimated light passing through the optical filter on an end of the output optical fiber; and
a positioning component for coinciding an optical axis of the first convergent rod lens with a center line between the input optical fiber and the output optical fiber.

10. The optical composite module according to claim 9, wherein the collimator includes:
a converging lens for focusing divergent light emitted from the light-emitting element on a single point; and
a second convergent rod lens placed between the optical filter and the converging lens for converting the light focused by the converging lens into collimated light and inputting the converted light into the optical filter.

11. The optical composite module according to claim 10, further comprising a back reflection preventing section placed between the converging lens and the second convergent rod lens for preventing the light, which is output from the converging lens and reflected by an end of the second convergent rod lens, from returning to the light-emitting element.

12. The optical composite module according to claim 11, wherein the back reflection preventing section is an optical isolator.

13. The optical composite module according to claim 11, wherein the back reflection preventing section prevents back reflection by angling an end of the second convergent rod lens.

14. The optical composite module according to claim 11, wherein the back reflection preventing section is an antireflective coating provided to an end of the second convergent rod lens.

15. The optical composite module according to claim 10, wherein the converging lens is a ball lens.

16. The optical composite module according to claim 10, wherein the converging lens is a rounded-end convergent rod lens whose lens end facing the light-emitting element is rounded.

17. The optical composite module according to claim 9, wherein the positioning component includes:
a cylindrical lens holder for holding the first convergent rod lens, an axis of the lens holder coinciding with the axis of the first convergent rod lens; and
an optical fiber holder whose outer diameter is equal to that of the lens holder, the optical fiber holder having two guide holes for holding the input optical fiber and output optical fiber such that the two optical fibers are placed equidistant from an axis thereof.

18. The optical composite module according to claim 9, wherein the positioning component whose outer diameter is equal to that of the first convergent rod lens is a package having two guide holes therein for holding the input optical fiber and the output optical fiber such that the two optical fibers are placed equidistant from the axis of the first convergent rod lens.

19. The optical composite module according to claim 9, further comprising a light-emitting element positioning component for placing the light-emitting element, when being adjusted to a predetermined angle such that the collimated light output from the collimator is focused on the end of the output optical fiber after passing through the optical filter and the first convergent rod lens.

20. The optical composite module according to claim 19, wherein the light-emitting element positioning component includes:
a cylindrical holder for holding the first convergent rod lens, an axis of the cylindrical holder coinciding with the axis of the first convergent rod lens; and
a light-emitting element holder whose outer diameter is equal to that of the cylindrical holder, the light-emitting element holder for securing the light-emitting element, and
the light-emitting element holder locks the light-emitting element so that the collimated light output from the collimator is focused on the end of the output optical fiber when being rotated so as to adjust a relative angle formed with the cylindrical holder to the predetermined angle.

21. An optical composite module that outputs light modulated by an inputted electric signal and multiplexes the modulated light and light having a plurality of wavelengths output from an input optical fiber for output to an output optical fiber, comprising:
a light-emitting element for emitting the light modulated by the inputted electric signal and focusing the emitted light on a single point;
a first convergent rod lens for converting the light focused by the light-emitting element into collimated light traveling in parallel with an optical axis;
an optical filter placed between the first convergent rod lens and the input and output optical fibers, the optical filter passing light of a predetermined range of wavelengths output from the first convergent rod lens and reflecting light outside of the predetermined wavelengths among light inputted thereinto;
a second convergent rod lens placed between the optical filter and the input and output optical fibers, the second convergent rod lens converting the light output from the input optical fiber into collimated light for inputting into the optical filter, and focusing the collimated light reflected by the optical filter and the collimated light passing through the optical filter on an end of the output optical fiber; and
a positioning component for coinciding an axis of the second convergent rod lens with an axis of the output optical fiber, wherein
an interface surface between the optical filter and the second convergent rod lens is angled so that the collimated light reflected by the optical filter and the collimated light passing through the optical filter are focused on the end of the output optical fiber.

22. The optical composite module according to claim 21, further comprising:
a first unit including the light-emitting element and the first convergent rod lens; and
a second unit including the optical filter, the second convergent rod lens, and the positioning component, wherein
the first unit and the second unit are operable to be mated and unmated.

23. An optical composite module that outputs light modulated by an inputted electric signal and multiplexes the modulated light and light having a plurality of wavelengths output from an input optical fiber for output to an output optical fiber, comprising:
a light-emitting element for emitting the light modulated by the inputted electric signal and focusing the emitted light on a single point;
a first convergent rod lens for converting the light focused by the light-emitting element into collimated light traveling in parallel with an optical axis;
an optical filter placed between the first convergent rod lens and the input and output optical fibers, the optical filter passing light of a predetermined range of wavelengths output from the first convergent rod lens and reflecting light outside of the predetermined wavelengths among light inputted thereinto;
a second convergent rod lens placed between the optical filter and the input and output optical fibers, the second convergent rod lens converting light output from the input optical fiber into collimated light for inputting into the optical filter, and focusing the collimated light reflected by the optical filter and the collimated light passing through the optical filter on an end of the output optical fiber; and
a positioning component for coinciding an axis of the second convergent rod lens with a center line between the input optical filter and the output optical fiber, wherein
the optical filter is provided with an angled end facing the first convergent rod lens so that the collimated light from the first convergent rod lens is refracted and focused on the end of the output optical fiber.

24. The optical composite module according to claim 23, further comprising:
a first unit including the light-emitting element and the first convergent rod lens; and
a second unit including the optical filter, the second convergent rod lens, and the positioning component, wherein
the first unit and the second unit are operable to be mated and unmated.

25. An optical composite module that demultiplexes light having a plurality of wavelengths output from an input optical fiber for converting light of a predetermined range of wavelengths into an electric signal and outputting light outside of the predetermined wavelengths to an output optical fiber, comprising:
an optical filter that passes the light falling within a predetermined range of wavelengths to be converted into the electric signal and reflects the light outside of the predetermined wavelengths;
a first convergent rod lens placed between the input and output optical fibers and the optical filter, the first convergent rod lens converting the light output from the input optical fiber into collimated light for inputting into the optical filter, and focusing the collimated light reflected by the optical filter on an end of the output optical fiber;
a second convergent rod lens for focusing the collimated light passing through the optical filter;
a light-receiving element for receiving the light focused by the second convergent rod lens and converting the received light into the electric signal; and
a positioning component for coinciding an optical axis of the first convergent rod lens with an axis of the input optical fiber, wherein
an interface surface between the optical filter and the first convergent rod lens is angled so that the collimated light reflected by the optical filter is focused on the end of the output optical fiber.

26. The optical composite module according to claim 25, wherein the interface surface between the optical filter and the first convergent rod lens is angled so that the collimated light passing through the optical filter travels in parallel with an optical axis.

27. The optical composite module according to claim 26, comprising:
a first unit including the light-receiving element and the second convergent rod lens; and
a second unit including the optical filter, the first convergent rod lens, and the positioning component, wherein
the first unit and the second unit are operable to be mated and unmated.

28. An optical composite module that demultiplexes light having a plurality of wavelengths output from an input optical fiber for converting light of a predetermined range of wavelengths into an electric signal and outputting light outside of the predetermined wavelengths to an output optical fiber, comprising:
an optical filter that passes the light falling within a predetermined range of wavelengths to be converted into the electric signal and reflects the light outside of the predetermined wavelengths;
a first convergent rod lens placed between the input and output optical fibers and the optical filter, the first convergent rod lens converting the light output from the input optical fiber into collimated light for inputting into the optical filter, and focusing the collimated light reflected by the optical filter on an end of the output optical fiber;
a second convergent rod lens for focusing the collimated light passing through the optical filter on a single point;
a light-receiving element for receiving the light focused by the second convergent rod lens and converting the received light into the electric signal; and
a positioning component for coinciding an optical axis of the first convergent rod lens with a center line between the input optical fiber and the output optical fiber.

29. The optical composite module according to claim 28, wherein the optical filter is provided with an angled end facing the second convergent rod lens so that the collimated light passing through the optical filter travels in parallel with an optical axis.

30. The optical composite module according to claim 29, comprising:
a first unit including the light-receiving element and the second convergent rod lens; and
a second unit including the optical filter, the first convergent rod lens, and the positioning component, wherein
the first unit and the second unit are operable to be mated and unmated.

31. An optical wavelength demultiplexer that receives a wavelength-multiplexed optical signal having a plurality of wavelengths and demultiplexes the received signal into optical signals on a wavelength basis, comprising:
a wavelength demultiplexing section for demultiplexing the received wavelength-multiplexed optical signal into at least two or more wavelength bands;
an optical signal demultiplexing section provided to each wavelength band for demultiplexing the optical signals in two or more wavelength bands into original optical signals on a wavelength basis, wherein
the optical signal demultiplexer is provided with a plurality of optical composite modules including a light-receiving element that demultiplexes a portion of the inputted optical signals for converting the demultiplexed signal into an electric signal, and outputs other optical signals, wherein
the plurality of optical composite modules are connected in series.

32. The optical wavelength demultiplexer according to claim 31, wherein the optical composite module is an optical composite module according to any one of claims 1, 9, and 25 to 30.

33. An optical wavelength multiplexer that wavelength-multiplexes optical signals having a plurality of wavelengths divided into at least two or more wavelength bands and outputs a wavelength-multiplexed signal, comprising:
an optical signal multiplexing section provided to each wavelength band for multiplexing optical signals having a plurality of wavelengths included in the wavelength band and outputting a multiplexed signal as an optical signal in the wavelength band; and
a wavelength band optical signal multiplexing section for multiplexing the optical signal in the wavelength band output from each optical signal multiplexing section for outputting, wherein
the optical signal multiplexing section is provided with a plurality of optical composite modules including a light-emitting element that outputs an optical signal modulated by an inputted electric signal and multiplexes the modulated optical signal and an inputted optical signal for outputting, and
the plurality of optical composite modules are connected in series.

34. The optical wavelength multiplexer according to claim 33, wherein the optical composite module is an optical composite module according to claims 9, and 21 to 24.

35. An optical composite module manufacturing method for manufacturing an optical composite module that converts convergent light emitted from a light-emitting element into collimated light traveling in parallel with an axis and outputs the converted light, comprising:
a process of removably inserting an optical fiber collimator into a split sleeve from one end thereof, the optical fiber collimator converting light output from an optical fiber whose axis coincides with the optical axis into collimated light traveling in parallel with the optical axis;
a process of inserting a lens holder holding a convergent rod lens into the split sleeve from another end thereof;
a process of fitting the lens holder into an alignment sleeve from an end thereof so as to allow the lens holder to be movable in a direction of an axis;
a process of determining a position of the convergent rod lens so that an output from the optical fiber becomes maximized when the light-emitting element is emitting light;
a process of securing the alignment sleeve and the lens holder, and securing the alignment sleeve and the light-emitting element at the position determined in the process of determining the position of the convergent rod lens; and
a process of pulling out the optical fiber collimator inserted into the split sleeve after the securing process.

36. An optical composite module manufacturing method for an optical composite module that focuses inputted collimated light on a single point and inputs the focused light into a light-receiving element, comprising:
a process of removably inserting an optical fiber collimator into a split sleeve from an end thereof, the optical fiber collimator converting light output from an optical fiber whose axis coincides with the optical axis into collimated light traveling in parallel with the optical axis;
a process of inserting a lens holder holding a convergent rod lens into the split sleeve from another end thereof;
a process of inserting the lens holder into an alignment sleeve from an end thereof so as to allow the lens holder to be movable in a direction of an axis;
a process of determining a position of the convergent rod lens so that an output from the light-receiving element becomes maximized when light is output from the optical fiber;
a process of securing the alignment sleeve and the lens holder, and securing the alignment sleeve and the light-receiving element at the position determined in the process of determining the position of the convergent rod lens; and
a process of pulling out the optical fiber collimator inserted into the split sleeve after the securing process.
